(19) United States
(12) Patent Application Publication
(10) Pub. No.: US 2003/0141394 A1
(43) Pub. Date: Jul. 31, 2003

(54) Self- propelling wood crusher machine and wood crusher

(76) Inventors: Kazunori Ueda, Tsuchiura-shi (JP); Kazuhide Seki, Tsukuba-shi (JP); Masamichi Tanaka, Tsuchiura-shi (JP); Yoshimi Shiba, Shimotsuma-shi (JP); Tsutomu Iida, Ibaraki-ken (JP); Makoto Yagishita, Ibaraki-ken (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/332,022

(22) PCT Filed: May 7, 2002
(86) PCT No.: PCT/JP02/04424

(30) Foreign Application Priority Data
May 22, 2001 (JP) 2001-152504

(51) Int. Cl. B02C 21/02

(52) U.S. Cl. 241/73; 241/101.74

(57) ABSTRACT

A self-propelling wood crushing machine comprises a body frame 10; travel devices 11 provided at both ends of the body frame 10 in the widthwise direction; a crusher provided substantially at the center of the body frame 10 in the longitudinal direction and including a crushing rotor 20 having a crushing bit 18 disposed on an outer periphery thereof; a carrier conveyor 3 provided on one side of the body frame 10 in the longitudinal direction to extend in the longitudinal direction of the body frame 10 and feeding wood to be crushed to the crusher; a pressing conveyor 5 comprising a pressing roller provided above the carrier conveyor 3 in the vicinity of the crusher, a drive roller provided on the side opposite to the pressing roller away from the crusher, and a feeding belt stretched between and wound around the pressing roller and the drive roller, the pressing conveyor 5 pressing the wood to be crushed while moving up and down, thereby introducing the wood to the crusher under cooperation with the feeding means 3; and a power unit 9 provided on the other side of the body frame 10 in the longitudinal direction.

### TECHNICAL FIELD

The present invention relates to an self-propelling wood crushing machine and a wood crushing machine for crushing pruned branches and lumber from thinning, limb and twig cuttings, scrap wood, etc.

### BACKGROUND ART

For example, pruned branches and lumber from thinning which are generated when cutting trees in forests and pruning the trees, limb and twig cuttings which are generated when turning the land into a housing site and when maintaining and managing green zones, or scrap wood that is generated when dismantling wooden houses, are in general finally treated as industrial wastes. Wood crushing machines are employed to crush the pruned branches, the limb and twig cuttings, etc. for the purpose of reducing the volume of the waste generated in the waste treating process or fermenting crushed wood after the crushing process so that the crushed wood is utilized as organic fertilizers.

That type of wood crushing machine is disclosed in, e.g., U.S. Pat. No. 5,947,395. The disclosed wood crushing machine comprises a body frame (chassis), traveling means (wheels) provided under the body frame, a crusher installed on the body frame and including a crushing rotor, which has crushing bits provided on its outer peripheral portion and is rotated for crushing wood to be crushed, feeding means (conveyor) installed above one side of the body frame in the longitudinal direction and feeding the wood to be crushed to the crusher, a pressing roller (roller) swinging about a fulcrum, as an axis of rotation, provided above the crushing rotor such that the roller moves farther away from the crushing rotor as it rotates upward, thereby introducing the wood to be crushed to the crusher while pressing the wood under cooperation with the feeding means, and a carrying-out conveyor (conveyor) installed above the body frame for carrying out the crushed wood to the outside of the wood crushing machine, the carrying-out conveyor having one side positioned below the crusher and the other side extended up to a position externally of the other side of the body frame in the longitudinal direction.

The disclosed wood crushing machine further comprises one fixed blade (anvil) disposed on a fixed blade support, which is disposed around the crushing rotor so as to position in the vicinity of the crushing rotor, and a sieving member (grate) provided around the crushing rotor with a gap left relative to the crushing rotor and having a plurality of openings through which the wood crushed by the crushing bits and the fixed blade pass.

In the wood crushing machine thus constructed, the wood introduced to be crushed is fed to the crusher side by the feeding means, is gripped by the pressing roller and the feeding means from above and below in a sandwiched relation, and is brought into a cantilevered state such that wood ends heading the crusher are projected toward the crushing rotor. The projected wood ends are hit by the crushing bits of the crushing rotor rotating upward, and are crushed (primary crushing). Thereafter, the crushed wood pieces further hit against the fixed blade provided around the crushing rotor on the downstream side in the rotating direction, and are further crushed (secondary crushing). Then, when the wood is crushed into pieces smaller than the opening area of the plurality of openings formed in the sieving member, the crushed wood passes through the sieving member and is carried out to the outside of the wood crushing machine by the carrying-out conveyor.

Also, for enabling the above-described wood crushing machine to travel, an self-propelling wood crushing machine additionally equipped with traveling means has already been proposed. In such an self-propelling wood crushing machine, traveling means comprising, e.g., endless tracks (crawlers) are provided on both sides of the body frame in the widthwise direction. By driving the endless tracks with hydraulic actuators, the wood crushing machine is automotive to travel in a work site or to move onto a bed of a transport trailer when transported to another place, so that the movement of the wood crushing machine within and to the work site is improved.

Generally, a very large space is required in a work site (wood crushing plant) in which the self-propelling wood crushing machine is employed, for example, to cut trees in forests, to turn the land into a housing site and to perform management of green zones, as described above. Specifically, there are needed a space for installation of the self-propelling wood crushing machine, a stock yard where a large quantity of wood to be crushed, such as pruned branches, lumber from thinning, and limb and twig cuttings, are stocked, and a storage space for storing crushed wood pieces generated by crushing the wood. Furthermore, a space for installation of a heavy machine, e.g., a hydraulic excavator, for loading the wood to be crushed to the self-propelling wood crushing machine, and a space for allowing the movement of a dump truck for carrying out the crushed wood pieces are also required. In particular, when crushing scrap wood in a site of dismantling, e.g., wooden houses as described above, it has recently become more difficult to secure a sufficient space for the wood crushing site because the work site is often near an urban district. For those reasons, the space occupied by the self-propelling wood crushing machine itself is preferably as small as possible, and a keen demand arises in reducing the size of the self-propelling wood crushing machine as far as possible.

When the self-propelling wood crushing machine is loaded on, e.g., a trailer and transported to the work site as described above, it is transported along public roads. Therefore, the self-propelling wood crushing machine must be designed so as to fall within predetermined transport limit dimensions (in height, widthwise and longitudinal directions) from the standpoint of preventing interference of the machine with surrounding structures such as guards and footbridges. Particularly, under recent situations of promoting reuse of wastes as represented by enforcement (October, 1991) of the Resource Reproduction Promotion Act (so-called Recycle Act), the usefulness of the self-propelling wood crushing machine is increasingly confirmed and wood recycling is endeavored by positively employing the self-propelling wood crushing machine even in a small-sized site. Therefore, the transport routes may include mountain roads, farm roads, etc. in which the allowable width and height are relatively small. From that point of view, too, a reduction in size of the self-propelling wood crushing machine is demanded.

However, conventional self-propelling wood crushing machines have not paid sufficient considerations in size reduction and compactness of the entire wood crushing machine, and the above-mentioned demands cannot be sufficiently coped with.

On the other hand, under the above-described recent situations of promoting reuse of wastes, higher quality of crushed wood pieces is also demanded and the wood piece size is required to fall within a predetermined target size range depending on the purpose of recycling.

In the wood crushing machine disclosed in the above-cited U.S. Pat. No. 5,947,395, the sieving member provided around the crushing rotor is replaceable. When trying to adjust the size range of the crushed wood pieces, plural kinds of sieving members having different areas of the openings are prepared beforehand, and the size of the crushed wood pieces passing through the sieving member can be adjusted by replacing the sieving member as required.

In the disclosed wood crushing machine, however, the crushing capability of the crushing rotor and the fixed blade remains the same, and the size of the crushed wood pieces is adjusted only depending on the opening area on the outlet side of the crushed wood pieces. When adjusting the size of the crushed wood pieces toward the smaller side, the crushed wood pieces continue to rotate around the crushing rotor on the inner peripheral side of the sieving member until the wood pieces are crushed so as to fall within the predetermined size range, thus resulting in a remarkable reduction of the crushing efficiency. Further, there is a possibility that the sieving member may be clogged and worn out in a shorter time.

### DISCLOSURE OF INVENTION

A first object of the present invention is to provide an self-propelling wood crushing machine in which the machine size can be sufficiently reduced in compliance with the recent demand.

A second object of the present invention is to provide a wood crushing machine in which the size of crushed wood pieces can be adjusted to fall within a desired range without reducing the crushing efficiency.

(1) To achieve the above object, an self-propelling wood crushing machine of the present invention comprises a body frame; traveling means provided at both ends of the body frame in the widthwise direction; a rotary crusher provided substantially at the center of the body frame in the longitudinal direction and including a crushing rotor having a crushing bit disposed on an outer periphery thereof; feeding means provided on one side of the body frame in the longitudinal direction to extend in the longitudinal direction of the body frame and feeding wood to be crushed to the crusher; a pressing conveyor comprising a pressing roller provided above the feeding means in the vicinity of the crusher, a drive roller provided on the side opposite to the pressing roller away from the crusher, and a feeding belt stretched between and wound around the pressing roller and the drive roller, the pressing conveyor pressing the wood to be crushed while moving up and down, thereby introducing the wood to the crusher under cooperation with the feeding means; and a power unit provided on the other side of the body frame in the longitudinal direction.

With the present invention, the traveling means are disposed at both ends of the body frame in the widthwise direction, and the crusher is disposed substantially at the center of the body frame in the longitudinal direction. In a sandwiching relation to the crusher, for example, the pressing conveyor and the feeding means are disposed on one side of body frame in a vertically opposing arrangement, while a carrying-out conveyor is disposed on the other side of the body frame. Thus, since those various components are disposed in concentrated layout on the one side, the other side and at the center of the body frame in the longitudinal direction, the components can be efficiently arranged without wasteful use of spaces. Hence, the entire size of the self-propelling wood crushing machine can be reduced. Consequently, a recent demand for size reduction can be satisfactorily coped with, which has arisen from, e.g., a difficulty in securing the wood crushing plant site, a narrower area of the plant site, and a standpoint of transport routes.

(2) In above (1), preferably, further comprising a mechanism for up and down movably supporting the pressing conveyor, wherein the mechanism for up and down movably supporting the pressing conveyor comprises a slider for holding the pressing conveyor, and hydraulic cylinders provided at both ends of the slider.

(3) In above (2), preferably, the mechanism for up and down movably supporting the pressing conveyor further comprises a link-type guide member for coupling the slider and a frame of the crusher.

(4) In any of above (1) to (3), preferably, further comprising driving means for rotationally driving the pressing conveyor contained inside the driver roll.

(5) In any of above (1) to (4), preferably, the feeding belt comprises an endless link stretched between and wound around the pressing roller and the drive roller, and a plurality of pressing plates having a substantially triangular cross-section and disposed side by side along an outer periphery of the link in the feeding direction of the wood to be crushed.

(6) In any of above (1) to (5), preferably, the pressing conveyor comprises a plurality of pressing rollers arranged side by side in the widthwise direction of the body frame, a plurality of drive rollers arranged side by side in the widthwise direction of the body frame in an opposed relation to the plurality of pressing rollers, and a plurality of feeding belts stretched between and wound around the plurality of pressing roller and the plurality of drive roller.

(7) In any of above (1) to (6), preferably, the self-propelling wood crushing machine further comprises a fixed blade support supporting at least one fixed blade positioned around a locus of rotation of the brushing bit and having a rotatable portion rotatable in a direction in which the fixed blade is released from an excessive load, when the excessive load is imposed on the fixed blade, detecting means for detecting rotation of the rotatable portion, and stop control means for controlling rotation of the crushing rotor to be stopped when the rotation of the rotatable portion is detected by said detecting means.

With those features, when wood to be crushed, foreign matters, etc., which have such a high hardness as raising a difficulty in crushing from the standpoint of the machine performance, are introduced to the crusher, the rotatable portion of the fixed blade support is rotated, allowing those materials to be ejected to the outside of the crusher. Responsively, the stop control means stops the rotation of the crushing rotor. As a result, the crushing rotor, the crushing bit, or the surrounding structures can be prevented from being damaged by hard wood to be crushed, hard foreign matters, etc.

(8) To achieve the above object, a wood crushing machine of the present invention comprises a crushing rotor having a crushing bit disposed on an outer periphery thereof; fixed blades disposed in a back-and-forth adjustable or replaceable manner on a fixed blade support provided around the crushing rotor such that a gap between the fixed blades and the crushing rotor is changeable; and a sieving member disposed with a gap left relative to the crushing rotor.

In the present invention, the wood to be crushed is first hit by the crushing bit of the crushing rotor for rough crushing (primary crushing). Then, the crushed pieces are caused to hit against the fixed blade, which is provided around the crushing rotor, e.g., on the downstream side in the rotating direction of the crushing rotor, for further crushing (secondary crushing). When the crushed pieces are cut into sizes smaller than an opening area of a plurality of openings formed in the sieving member, for example, which is provided around the crushing rotor, those crushed pieces are delivered to the exterior through the openings.

On that occasion, the size of the crushed pieces after being crushed by the fixed blade depends on the gap between the blade and the crushing rotor (more precisely, the gap size between the fixed blade and the locus of rotation of the crushing bit. In the present invention, taking into account the above, the fixed blade is disposed in a back-and-forth adjustable or replaceable manner on the fixed blade support provided around the crushing rotor. With such an arrangement, the size of the crushed pieces after being crushed by the fixed blade can be adjusted to a desired value by changing the gap between the fixed blade and the crushing rotor as desired.

Accordingly, when adjusting the size of the crushed pieces to a desired value regardless of either a smaller or larger size side, the crushed pieces adjusted so as to fall within a desired size range can be obtained while maintaining good crushing efficiency, for example, by replacing the sieving member with another one having openings of which area corresponds to the desired piece size and adjusting the gap size of the variable blade relative to the crushing rotor to a value corresponding to the desired piece size.

(9) Also, to achieve the above object, a wood crushing machine of the present invention comprises a crushing rotor having a crushing bit disposed on an outer periphery thereof; a first fixed blade disposed on a fixed blade support provided around the crushing rotor; second fixed blades disposed in a back-and-forth adjustable or replaceable manner on a fixed blade support provided around the crushing rotor such that a gap between the second fixed blades and the crushing rotor is changeable; and a sieving member disposed with a gap left relative to the crushing rotor.

(10) In above (9), preferably, the second fixed blades is disposed in plural such that gaps between the fixed blades and the crushing rotor are gradually decreased in the rotating direction of the crushing rotor.

(11) In above (9) or (10), preferably, a spacer capable of changing the gap between the second fixed blades and the crushing rotor is extractably inserted between the second fixed blades and the fixed blade support.

(12) In above (11), preferably, the spacer has a rectangular cross-sectional shape.

With those features, the second fixed blade can be adjusted in two steps in the back-and-forth direction relative to the fixed blade support depending on a size difference between a long side and a short side of the rectangular sectional shape of the spacer by rotating the spacer, which has been withdrawn out of between the second fixed blade and the fixed blade support, by 90 degrees, and then inserting the spacer again. Thus, the gap size between the second fixed blade and the crushing rotor can be easily adjusted in two steps.

### BRIEF DESCRIPTION OF THE DRAWINGS

FIG. 1 is a side view showing an overall structure of one embodiment of an self-propelling wood crushing machine of the present invention.

FIG. 2 is a plan view showing the overall structure of the one embodiment of the self-propelling wood crushing machine of the present invention.

FIG. 3 shows a front view of the one embodiment of the self-propelling wood crushing machine of the present invention, shown in FIG. 1, looking in the direction of an arrow A, and a rear view looking in the direction of an arrow B.

FIG. 4 is a partial enlarged side view showing a structure in the vicinity of a crushing unit constituting the one embodiment of the self-propelling wood crushing machine of the present invention.

FIG. 5 is a side view, partly seen through, showing the structure in the vicinity of the crushing unit constituting the one embodiment of the self-propelling wood crushing machine of the present invention.

FIG. 6 is a side view, partly broken away, taken along a plane VI-VI in FIG. 1 and showing a structure in the vicinity of a pressing conveyor constituting the one embodiment of the self-propelling wood crushing machine of the present invention.

FIG. 7 is a partial enlarged view of FIG. 1, partly sectioned, showing a detailed structure of the pressing conveyor constituting the one embodiment of the self-propelling wood crushing machine of the present invention.

FIG. 8 is a transverse sectional view, taken along a section VIII-VIII in FIG. 7, showing the detailed structure of the pressing conveyor constituting the one embodiment of the self-propelling wood crushing machine of the present invention.

FIG. 9 is a sectional view showing the detailed structure of the pressing conveyor constituting the one embodiment of the self-propelling wood crushing machine of the present invention, in which the right half is a transverse sectional view taken along a section IXA-IXA in FIG. 7 and the left half is a transverse sectional view taken along a section IXB-IXB in FIG. 7.

FIG. 10 is a transverse sectional view, taken along a section X-X in FIG. 5, showing a detailed structure of a part of a fixed blade support, i.e., a variable anvil accommodating portion for accommodating a variable anvil, constituting the one embodiment of the self-propelling wood crushing machine of the present invention.

FIG. 11 is a transverse sectional view showing a detailed structure of a modification of the variable anvil accommodating portion for accommodating the variable anvil in the one embodiment of the self-propelling wood crushing machine of the present invention.

FIG. 12 is a transverse sectional view showing the detailed structure of another modification of the variable anvil accommodating portion for accommodating the variable anvil in the one embodiment of the self-propelling wood crushing machine of the present invention.

FIG. 13 is a transverse sectional view showing the detailed structure of the other modification of the variable anvil accommodating portion for accommodating the variable anvil in the one embodiment of the self-propelling wood crushing machine of the present invention.

FIG. 14 is a partial enlarged side view showing a structure in the vicinity of a crushing unit according to a modification of the one embodiment of the self-propelling wood crushing machine of the present invention.

FIG. 15 is a partial enlarged side view showing a structure in the vicinity of a crushing unit constituting another embodiment of the self-propelling wood crushing machine of the present invention.

FIG. 16 is a side view, partly seen through, showing the structure in the vicinity of the crushing unit constituting the other embodiment of the self-propelling wood crushing machine of the present invention.

FIG. 17 is a partial enlarged view of an extracted part of FIG. 16, showing a detailed structure of a shear pin support constituting the other embodiment of the self-propelling wood crushing machine of the present invention.

FIG. 18 is a plan view, looking in the direction C, of the shear pin support constituting the other embodiment of the self-propelling wood crushing machine of the present invention shown in FIG. 17.

FIG. 19 is a transverse sectional view, taken along a section IXX-IXX in FIG. 16, showing a detailed structure of a variable anvil accommodating portion constituting the other embodiment of the self-propelling wood crushing machine of the present invention.

FIG. 20 is a partial enlarged view of an extracted principal part of FIG. 16, showing a detailed structure of a pressing conveyor constituting the other embodiment of the self-propelling wood crushing machine of the present invention.

FIG. 21 is a sectional view, partly broken away, taken along a section XXI-XXI in FIG. 16 and showing the detailed structure of the pressing conveyor constituting the other embodiment of the self-propelling wood crushing machine of the present invention.

FIG. 22 shows a side view, a front view, a plan view and a transverse sectional view of a pressing plate provided in the pressing conveyor constituting the other embodiment of the self-propelling wood crushing machine of the present invention.

FIG. 23 is a plan view, looking in the direction F, of the pressing conveyor constituting the other embodiment of the self-propelling wood crushing machine of the present invention shown in FIG. 16.

FIG. 24 is a partial enlarged view showing a detailed structure of hydraulic motors, including the surroundings thereof, provided in the pressing conveyor constituting the other embodiment of the self-propelling wood crushing machine of the present invention.

FIG. 25 is a side view showing an overall structure of a pressing conveyor supporting mechanism constituting the other embodiment of the self-propelling wood crushing machine of the present invention.

FIG. 26 is a hydraulic circuit diagram showing an overall schematic construction of a hydraulic drive system constituting the other embodiment of the self-propelling wood crushing machine of the present invention.

FIG. 27 is a hydraulic circuit diagram showing a detailed construction of a first control valve device constituting the other embodiment of the self-propelling wood crushing machine of the present invention.

FIG. 28 is a hydraulic circuit diagram showing a detailed construction of an operating valve device constituting the other embodiment of the self-propelling wood crushing machine of the present invention.

FIG. 29 is a hydraulic circuit diagram showing a detailed construction of a second control valve device constituting the other embodiment of the self-propelling wood crushing machine of the present invention.

FIG. 30 is a flowchart representing control details concerned with crusher stop control in control functions of a controller constituting the other embodiment of the self-propelling wood crushing machine of the present invention.

### BEST MODE FOR CARRYING OUT THE INVENTION

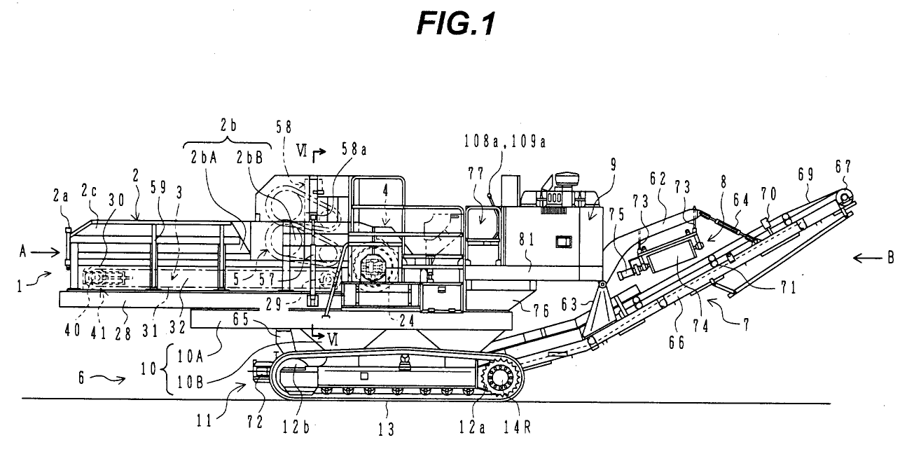

One embodiment of an self-propelling wood crushing machine of the present invention will be described below with reference to FIGS. 1 to 14.

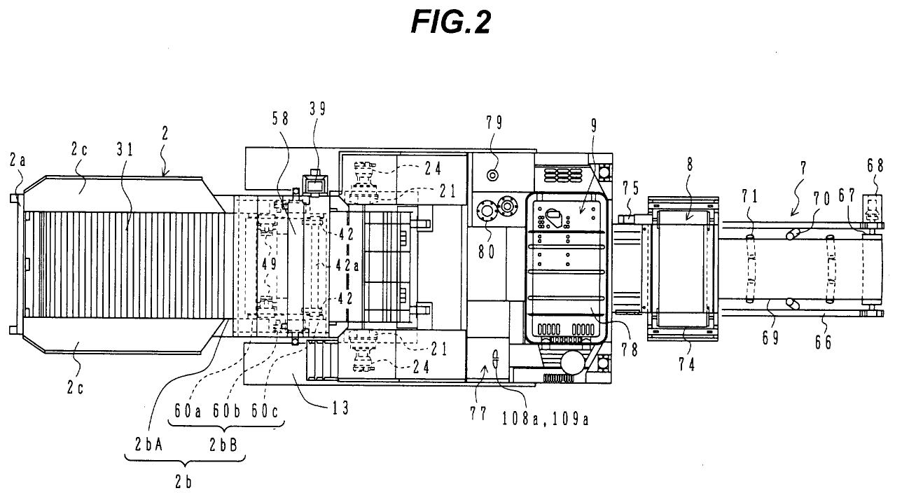

FIG. 1 is a side view showing an overall structure of the one embodiment of the self-propelling wood crushing machine of the present invention, and FIG. 2 is a plan view of the one embodiment of the self-propelling wood crushing machine of the present invention shown in FIG. 1.

Referring to FIGS. 1 and 2, an illustrated wood crushing machine is an self-propelling wood crushing machine capable of traveling by itself. Numeral 1 denotes a body of the crushing machine, which is equipped with a hopper 2, a carrier conveyor 3, a crushing unit 4, and a pressing conveyor 5. Also, numeral 6 denotes a travel structure installed under the crushing machine body 1, 7 denotes a carrying-out conveyor, 8 denotes a magnetic separator, and 9 denotes a power body serving as a power unit.

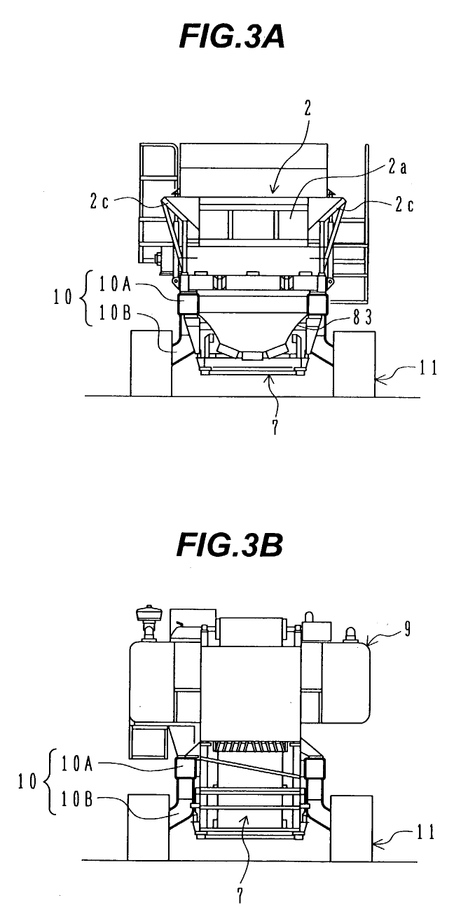

FIG. 3(a) is a front view looking in the direction of an arrow A in FIG. 1, and FIG. 3(b) is a rear view looking in the direction of an arrow B in FIG. 1. Referring to FIGS. 3(a) and 3(b), the travel structure 6 comprises a body frame 10 and travel devices 11 provided on both sides of the body frame 10 (in the left-to-right direction in FIGS. 3(a) and 3(b)). The body frame 10 comprises a crushing machine mount portion 10A, which is formed by a frame having, for example, a substantially rectangular shape and mounts thereon the hopper 2, the crushing unit 4, the power unit 9, etc., and a track frame portion 10B provided under the crushing machine mount portion 10A.

Returning to FIGS. 1 and 2, the travel devices 11 comprise drive wheels 12a and idlers 12b rotatably supported by the track frame portion 10B, endless tracks 13 extended between the drive wheels 12a and the idlers 12b and serving as traveling means, and left and right travel hydraulic motors 14L, 14R provided on the same side as the drive wheels 12a.

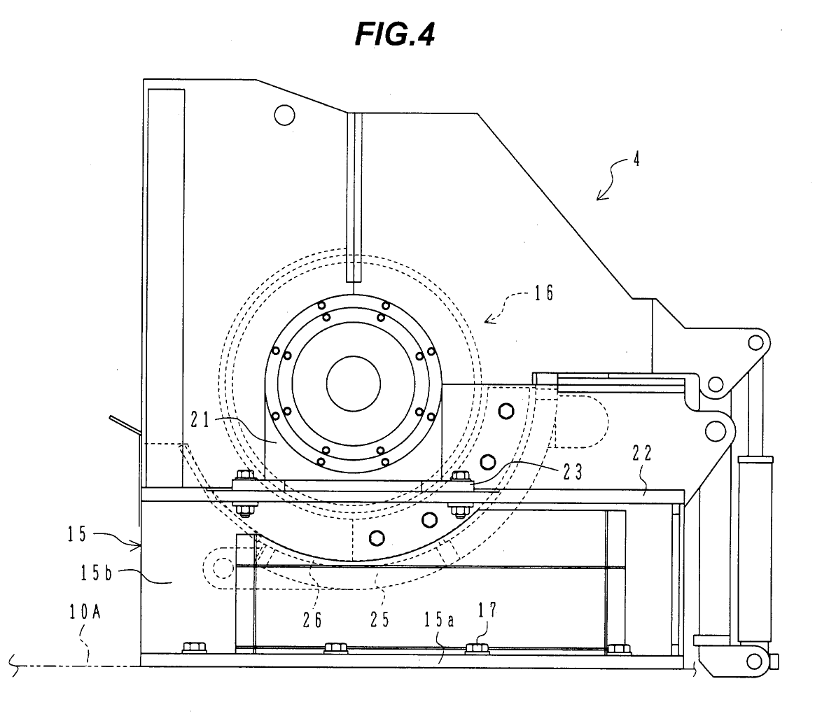

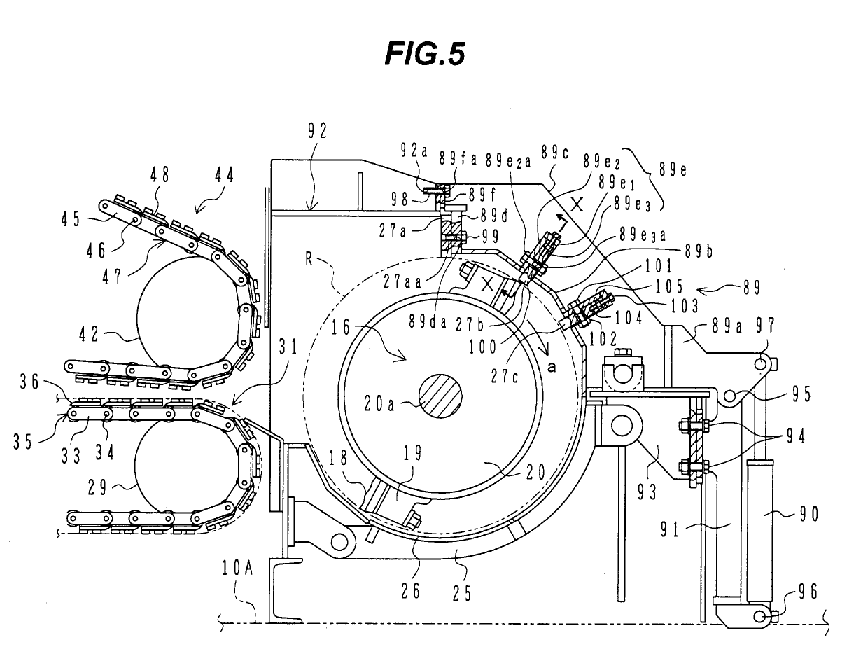

The crushing unit 4 is mounted above substantially a central portion of the crushing machine mount portion 10A of the body frame in the longitudinal direction (left-to-right direction in FIGS. 1 and 2). FIG. 4 is an enlarged side view of a part of FIG. 1, showing a structure in the vicinity of the crushing unit 4, and FIG. 5 is a side view, partly seen through, of the structure shown in FIG. 4.

Referring to FIGS. 4 and 5, numeral 15 denotes a base mounted to the crushing machine mount portion 10A of the body frame, and 16 denotes a crusher.

The base 15 comprises a bottom plate 15a provided at a lowermost portion, and side plates 15b vertically provided on the bottom plate 15a at both left and right sides thereof. Penetration holes (not shown) for insertion of bolts 17 are formed in the bottom plate 15a, and the bottom plate 15a is fixedly fastened to the crushing machine mount portion 10A of the body frame using the bolts 17 inserted into the penetration holes.

The crusher 16 is a rotary uniaxial crusher (so-called impact crusher in this embodiment). The crusher 16 includes a rotor (crushing rotor) 20 provided on its outer periphery with crushing bits 18 (of which crushing outer diameter R is denoted by an imaginary line and which is replaceable with hitting plates) serving as blades and fixtures 19 for fixing the crushing bits 18.

Both ends of a rotary shaft 20a of the crushing rotor 20 are rotatably supported by bearing mechanisms 21, 21 provided on the left and right side plates 15b, 15b. Each bearing mechanism 21 is mounted to an outer surface of the corresponding side plate 15b in the widthwise direction, and it is placed and supported, through an intermediate member 23, on and by a support stand 22 provided on the base bottom plate 15a. The hydraulic motors 24, 24 for the crusher are provided on the side outside the bearing mechanisms 21 (see FIGS. 1 and 2), and their drive shafts (not shown) are coupled to the rotary shaft 20a of the crushing rotor 20 through couplings (not shown). Around the crushing rotor 20, a sieving member (grate) 26 substantially in the form of a partial cylindrical surface is disposed which is supported by a support member 25 with a predetermined gap left relative to the crushing rotor 20 and which has a number of openings (not shown) having the function of setting the size of crushed wood pieces and allowing the crushed wood pieces to pass through them. Though not described in detail, the sieving member 26 is replaceable, as required, by removing the support member 25 (or rotating it to move away from the crushing rotor 20).

The crushing bits 18 are arranged such that their edge surfaces are faced in the forward rotating direction of the crushing rotor 20 (direction of an arrow (a) in FIG. 5). Numeral 27 denotes an anvil (secondary crushing plate or repulsive plate), serving as a fixed blade (not-rotating blade) fixedly provided on the outer peripheral side of the crusher 16 (specifically, around the crushing rotor 20). In this embodiment, three anvils 27a, 27b and 27c are provided.

Returning to FIGS. 1 and 2, the carrier conveyor 3 is mounted on an intermediate frame 28, which is provided on the front side (left side in FIGS. 1 and 2) of the crushing machine mount portion 10A of the body frame, so as to lie in the longitudinal direction of the body frame 10 and to extend substantially horizontally below the hopper 2. Then, the carrier conveyor 3 comprises a feed roller 29 (see also FIG. 5) being in the form of, e.g., a sprocket and provided at one end thereof on the side closer to the crusher 16 (rear side of the self-propelling wood crushing machine (right side in FIGS. 1 and 2), a driven roller 30 provided on the other side (front side of the wood crushing machine), and a feeding belt (conveyor belt) 31 extended between and wound around the feed roller 29 and the driven roller 30. Numeral 32 denotes a conveyor belt cover.

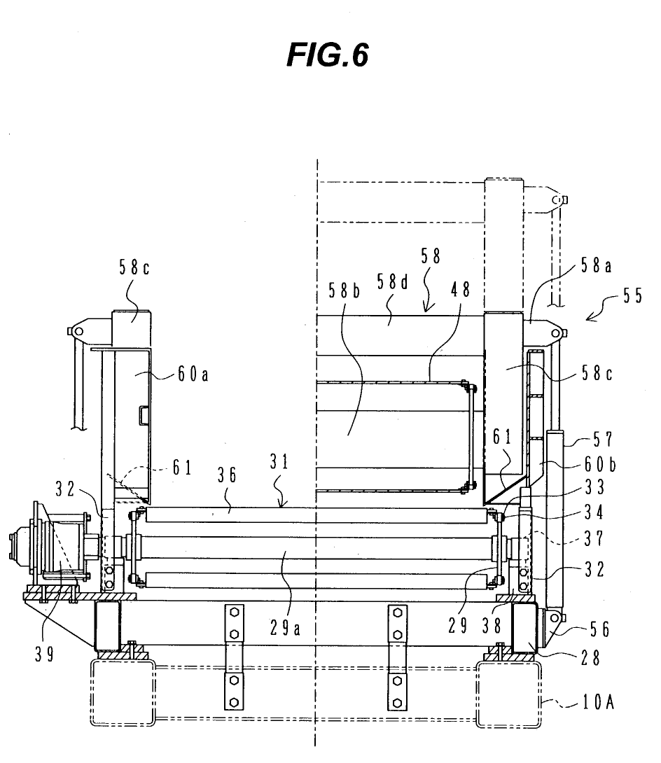

FIG. 6 is a side view, partly broken away, taken along a plane VI-VI in FIG. 1. Referring to FIG. 6 as well as FIG. 5, the feeding belt 31 comprises endless links 35 provided on both left and right sides of the self-propelling wood crushing machine in the widthwise direction and each made up of many link members 33 rotatably articulated between adjacent two through pins 34, and a plurality of feed plates 36 arranged side by side in the feeding direction of the crushed wood pieces and each fixed in a bridging relation between the endless links 35 and 35 in the widthwise direction of the self-propelling wood crushing machine. Further, numeral 37 denotes a bearing mechanism held on the intermediate frame 28 through a support member 38 and supporting one of both ends of a rotary shaft 29a of the feed roller 29, and 39 denotes a hydraulic motor for the carrier conveyor (see also FIG. 2), which is disposed at the end of the feed roller rotary shaft 29a on the right side of the self-propelling wood crushing machine (left side in FIG. 6) and is coupled to the rotary shaft 29a outside the bearing mechanism 37 in the axial direction. In addition, bearing mechanisms 40 (see FIG. 1) for supporting a rotary shaft (not shown) of the driven roller 30 are constructed to be displaceable substantially in the horizontal direction with known tension adjusting mechanisms 41 so that the tension of the feeding belt 31 can be adjusted.

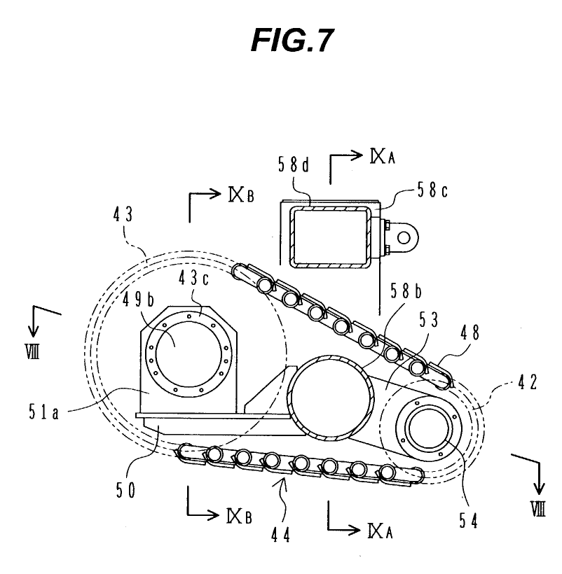

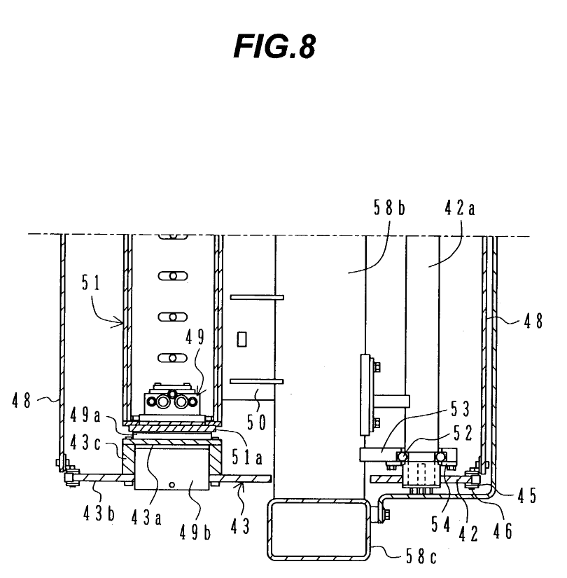

Returning to FIGS. 1 and 2, the pressing conveyor 5 is up and down movably provided above the end of the carrier conveyor 3 on the side closer to the crusher 16. FIG. 7 is a partial enlarged view of FIG. 1, partly sectioned, showing a detailed structure of the pressing conveyor 5 (although a drive roller 43, a pressing roller 42 and a slider 58 (described below) are partly omitted from the figure for clarifying the structure), and FIG. 8 is a transverse sectional view taken along a section VIII-VIII in FIG. 7.

Referring to FIGS. 7 and 8, the pressing conveyor 5 comprises the pressing roller 42 being in the form of a sprocket and provided above the carrier conveyor 3 near the crusher 16 (specifically at the end of the carrier conveyor 3 closer to the crusher 16), the drive roller 43 being in the form of a sprocket, which has a larger diameter than the pressing roller 42, and provided on the side opposite to the pressing roller 42 (front side of the self-propelling wood crushing machine, the inlet side of the wood to be crushed), and a feeding belt (conveyor belt) 44 extended between and wound around the drive roller 43 and the pressing roller 42.

The feeding belt 44 has substantially the same structure as the feeding belt 31 of the carrier conveyor 3. In other words, the feeding belt 44 comprises two endless links 47 provided on both left and right sides of the self-propelling wood crushing machine in the widthwise direction and each made up of many link members 45 rotatably articulated between adjacent two through pins 46 (see FIG. 5), and a plurality of feed plates 48 arranged side by side in the feeding direction of the wood to be crushed and each fixed in a bridging relation between the endless links 47 and 47 in the widthwise direction of the self-propelling wood crushing machine (see FIG. 5).

Further, numeral 49 denotes a hydraulic motor for the pressing conveyor, which is disposed on the radially inward side of each of the drive rollers 43, 43.

With such a structure that the pressing conveyor hydraulic motors 49 as driving sources for the pressing conveyor 5 are arranged on the drive roller 43 side, the diameter of the pressing roller 42 can be reduced. As a result, the pressing roller 42 can be positioned as close as possible to the crushing rotor 20 (precisely speaking, the crushing outer diameter R) (described later in detail).

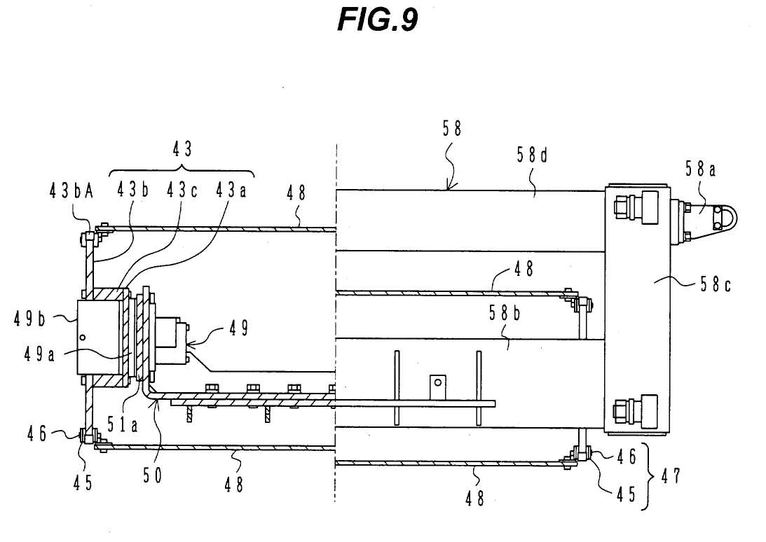

In FIG. 9, the right half is a transverse sectional view taken along a section IXA-IXA in FIG. 7 and the left half is a transverse sectional view taken along a section IXB-IXB in FIG. 7. Referring to FIG. 9 as well as FIG. 8, the pressing conveyor hydraulic motor 49 is fixed to a side wall 51a of a bracket 51, which is provided on a support member 50 attached to an inserted portion 58b of a slider 58 (described later), and it is arranged so as to locate on the inner peripheral side of the feeding belt 44 within the dimension substantially in the widthwise direction (in the axial direction of the drive roller 43, in the vertical direction in FIG. 8, or in the left-to-right direction in FIG. 9). A larger-diameter driving force output portion 49a of the pressing conveyor hydraulic motor 49 is positioned axially inward of its substantially cylindrical portion 49b.

The drive roller 43 in the form of a sprocket comprises a substantially ring-shaped mount portion 43a fixed to the larger-diameter driving force output portion 49a of the pressing conveyor hydraulic motor 49, a substantially disk-shaped outer peripheral portion 43b, which is positioned axially outward of the mount portion 43a on the outer peripheral side of the substantially cylindrical portion 49b of the pressing conveyor hydraulic motor and has a saw-toothed portion 43bA formed at its outermost periphery for engagement with the endless link 47, and a substantially cylindrical intermediate portion 43c axially extended on the outer peripheral side of the substantially cylindrical portion 49b of the pressing conveyor hydraulic motor for connection between the mount portion 43a and the outer peripheral portion 43b.

Also, the pressing roller 42 in the form of a sprocket is fixed to both ends of a rotary shaft 42a supported by bearings 52, 52. The bearings 52, 52 are fixed, through ring-shaped plates 54, to a connecting member 53 provided on the opposite side to the support member 50 attached to the slider inserted portion 58b. As with the drive roller 43, the pressing roller 42 is also arranged so as to locate on the inner peripheral side of the feeding belt 48 within the dimension substantially in the widthwise direction.

The pressing conveyor 5 is provided to be slidable by a pressing conveyor support mechanism 55 in the vertical direction. Referring to FIGS. 6 and 9, the pressing conveyor support mechanism 55 includes, on both left and right ends, a pair of left and right hydraulic cylinders 57, 57 extended substantially in the vertical direction and each having one end (lower end) connected to a bracket 56 provided near the end of the intermediate frame 28 closer to the crusher 16, and brackets 58a connected to the other ends (upper ends) of the hydraulic cylinders 57, 57. The pressing conveyor support mechanism 55 further includes the slider 58 provided to be slidable in the vertical direction upon extension and contraction of the hydraulic cylinders 57, 57.

The slider 58 comprises inserted portion 58b having a substantially cylindrical shape, disposed to extend substantially in the horizontal direction and inserted to the inner peripheral side of the feeding belt 44, a pair of left and right vertical beams 58c, 58c fixed to both left and right ends of the inserted portion 58b extended substantially in the vertical direction, the brackets 58a, 58a projecting from the vertical beams 58c, 58c outward of the self-propelling wood crushing machine in the widthwise direction, and a horizontal beam 58d disposed above the inserted portion 58b to extend substantially in the horizontal direction for connection between upper ends of the vertical beams 58c, 58c.

With the structure described above, the slider 58 and the pressing conveyor 5 are constructed to be slidable (movable toward or away from the carrier conveyor 3) as an integral unit in the vertical direction, whereby the pressure applied from the pressing conveyor 5 for pressing the crushed wood pieces and the gap size between the feeding belt 31 of the carrier conveyor 3 and the feeding belt 44 of the pressing conveyor 5 can be set as required.

Returning to FIGS. 1 and 2, the hopper 2 is mounted substantially horizontally to the intermediate frame 28 through support members 59. Numeral 2a denotes a side wall of the hopper at a front end of the self-propelling wood crushing machine, and 2b, 2b denote side walls of the hopper at both (left and right) sides of the self-propelling wood crushing machine in the widthwise direction. Each of the side walls 2b at both the sides in the widthwise direction comprise a wood material loading portion 2bA positioned on the front side of the self-propelling wood crushing machine so as to cover an upper lateral area of a portion of the pressing conveyor 3 corresponding to the front side of the self-propelling wood crushing machine, and a pressing conveyor covering portion 2bB positioned nearer to the rear side of the self-propelling wood crushing machine than the wood material loading portion 2bA so as to cover an upper lateral area of a portion of the pressing conveyor 3 corresponding to the rear side of the self-propelling wood crushing machine and a lateral area of the pressing conveyor 5. A spreading (flaring) portion 2c in the upward spreading form is provided at a top of the wood material loading portion 2bA for more convenience when loading the wood to be crushed.

The pressing conveyor covering portion 2bB comprises a drive roller accommodating portion 60a continuously extended from the wood material loading portion 2bA substantially in a flush relation toward the rear side of the self-propelling wood crushing machine and facing each of both widthwise ends of the driver roller 43 of the pressing conveyor 5 with a small gap left therebetween, a slider accommodating portion 60b positioned closer to the rear side of the self-propelling wood crushing machine than the drive roller accommodating portion 60a, projecting in the widthwise direction of the self-propelling wood crushing machine and facing the slider vertical beam 58c of the pressing conveyor support mechanism 55 with a small gap left therebetween, and a pressing roller accommodating portion 60c positioned closer to the rear side of the self-propelling wood crushing machine than the slider accommodating portion 60b and facing each of both widthwise ends of the pressing roller 42 of the pressing conveyor 5 with a small gap left therebetween. Then, as shown in FIG. 2, the wood material loading portion 2bA, the drive roller accommodating portion 60a, and the pressing roller accommodating portion 60c are arranged to lie substantially on one straight line, and the distances between the left and right wood material loading portions 2bA, 2bA, between the left and right drive roller accommodating portions 60a, 60a, and between the left and right pressing roller accommodating portions 60c, 60c are all almost equal to each other.

Also, referring to FIG. 6, numeral 61 denotes a crushed wood guide provided to obliquely extend in the vicinity of a joint between a lower end of the slider accommodating portion 60b and an upper end of the carrier conveyor cover 32. In an area of the slider accommodating portion 60b having a slightly larger size in the widthwise direction of the self-propelling wood crushing machine as described above, the crushed wood guide 61 serves to prevent the crushed wood from protruding and spilling out to the exterior beyond the widthwise size of the feeding belt 31 of the carrier conveyor 3.

Returning to FIGS. 1 and 2, a portion of the carrying-out conveyor 7 on the delivery side (rear side of the self-propelling wood crushing machine, right side in FIGS. 1 and 2) is suspended, through support members 63, 64, from an arm member 62 (omitted in FIG. 2) projecting from the power unit 9. Also, a portion of the carrying-out conveyor 7 on the side (front side, left side in FIGS. 1 and 2) opposite to the delivery side is positioned below the crushing machine mount portion 10A of the body frame and is suspended from the crushing machine mount portion 10A of the body frame through a support member 65. As a result, the carrying-out conveyor 7 is disposed to extend obliquely upward to the exterior of the body frame 10 on the rear side of the self-propelling wood crushing machine while passing under the body frame 10 and under the power unit 9.

Further, numeral 66 denotes a frame, 67 denotes a drive wheel supported by the frame 66, 68 denotes a carrying-out conveyor hydraulic motor (see FIG. 2) for driving the drive 67, 69 denotes a conveyor belt stretched between and wound around the drive wheel 67 and a driven wheel (not shown), and 70 and 71 denote respectively a guide roller and a roller for supporting both side surfaces and a feed surface of the conveyor belt 69. Additionally, numeral 72 denotes a known tension adjusting mechanism capable of substantially horizontally displacing bearing mechanisms (not shown) supporting a rotary shaft of the driven wheel so that the tension of the conveyor belt 69 can be adjusted.

The magnetic separator 8 is suspended from the arm member 62 through support members 73, 73. The magnetic separator 8 comprises a magnetic separator belt 74 arranged above the conveyor belt 69 to extend substantially perpendicular to it, a magnetic force generating means (not shown), and a hydraulic motor 75 for the magnetic separator 8.

The power unit 9 is mounted, through a power unit resting member 76, above the end of the crushing machine mount portion 10A of the body frame on the rear side of the self-propelling wood crushing machine. A cab 77 is provided in front of the power unit 9 on the left side.

Herein, the carrier conveyor 3, the crusher 16, the pressing conveyor 5, the carrying-out conveyor 7, the magnetic separator 8, the travel devices 11, and the pressing conveyor support mechanism 55 constitute driven components that are driven by the hydraulic drive system equipped in the self-propelling wood crushing machine. Those components are driven by the hydraulic drive system comprising various hydraulic actuators, such as the carrier conveyor hydraulic motor 39, the crusher hydraulic motors 24, the pressing conveyor hydraulic motors 49, the carrying-out conveyor hydraulic motor 68, the magnetic separator hydraulic motor 75, the left and right travel hydraulic motors 14L, 14R, and the hydraulic cylinder 57 for up and down moving the pressing conveyor, an engine (not shown) mounted in the power unit 9, at least one hydraulic pump (not shown) driven by the engine, a plurality of control valves (not shown), and so on.

The hydraulic pump and the engine (only an upper cover 78 is shown in FIG. 2) are arranged in an area of the power unit 9 closer to the rear side of the self-propelling wood crushing machine side by side in the widthwise direction of the self-propelling wood crushing machine along with a heat exchanger (not shown) including a radiator for cooling engine cooling water. On the other hand, in an area of the power unit 9 closer to the front side of the self-propelling wood crushing machine, there are disposed side by side an engine fuel reservoir (only a fuel supply port 79 is shown in FIG. 2), a working oil reservoir (only an oil supply port 80 is shown in FIG. 2) for storing a hydraulic fluid (working oil) used to drive the various hydraulic actuators, a control valve device (not shown) including the plurality of control valves, and the cab 77 in which an operator is seated, in that order from the right side (upper side in FIG. 2) to the left side (lower side in FIG. 2) in the widthwise direction of the self-propelling wood crushing machine.

The above-described components of the power unit 9 are arranged on a power unit frame 81 (see FIG. 1) serving as a lower base structure of the power unit 9, and the power unit frame 81 is mounted above a rear end of the crushing machine mount portion 10A of the body frame through the power unit resting member 76 (see FIG. 1).

In the self-propelling wood crushing machine having the above-described construction, this embodiment has one feature as follows. The travel devices 11 are disposed on both sides of the track frame portion 10B of the body frame in the widthwise direction, and the crusher 16 is disposed near the center of the crushing machine mount portion 10A of the body frame in the back-and-forth direction. In a sandwiching relation to the crusher 16, there are disposed, on the front side of the crushing machine mount portion 10A of the body frame, the carrier conveyor 3 and the pressing conveyor 5 located above the end of the carrier conveyor 3 closer to the crusher 16, and the power unit 9 on the rear side of the crushing machine mount portion 10A of the body frame. Further, the carrying-out conveyor 7 is arranged so as to extend from a position below the crushing machine mount portion 10A of the body frame, which corresponds to the crusher 16, to a position outside the rear side of the body frame 10. Thus, since the various components are disposed in concentrated and well-balanced layout at the front side, the rear side, the center and the underside of the body frame 10, those components can be efficiently arranged without wasteful use of spaces.

Another feature of this embodiment resides in that, of the anvils 27a, 27b and 27c, the two anvils 27b and 27c positioned on the downstream side are adjustable to move toward and away from the crushing rotor 20, whereby the gap relative to the crushing rotor can be changed (more specifically, those two anvils are slidable in the direction vertical to the crushing rotor 20). The anvil 27a positioned on the most upstream side in the rotating direction of the crushing rotor 20 is a fixed anvil. The structure of the anvils will be described below in detail.

Referring to FIG. 5, numeral 89 denotes a fixed blade support (support member), 89a denotes a bracket portion of the fixed blade support, 90 denotes a hydraulic cylinder for opening and closing the fixed blade support, 91 denotes a cylinder support bracket, and 92 denotes an upper base attached to any suitable member (e.g., the side plate 15b) on the stationary side of the crushing unit 4.

The fixed blade support 89 comprises the bracket portion 89a, an inner wall 89b extended in a bent shape following a locus R of rotation of the crushing bits 18 as close as possible, side walls 89c, 89c provided at both ends of the inner wall 89b in the axial direction (direction vertical to the drawing sheet in FIG. 5), a fixed anvil mount portion 89d provided near an end of the inner wall 89b on the front side (left side in FIG. 5) of the self-propelling wood crushing machine, variable anvil accommodating portions 89e provided in two positions that divide the inner wall 89b substantially into three parts in the circumferential surface, and a mount portion 89f provided at an end of the fixed blade support closer to the front side of the self-propelling wood crushing machine.

The cylinder support bracket 91 is fixedly fastened by bolts 94 to a support stand 93 that is fixed to any suitable member (e.g., the stand 22) on the stationary side of the crushing unit 4. A lower end of the bracket portion 89a of the fixed blade support is rotatably coupled to an upper end of the cylinder support bracket 91 through a pin 95. A lower end of the hydraulic cylinder 90 for opening and closing the fixed blade support is rotatably coupled to a lower end of the cylinder support bracket 91 through a pin 96, and an upper end of the hydraulic cylinder 90 for opening and closing the fixed blade support is rotatably coupled to the bracket portion 89a of the fixed blade support through a pin 97.

A penetration hole 89fa is formed in the mount portion 89f of the fixed blade support. In a closed state of the fixed blade support 89 shown in FIG. 5, the fixed blade support 89 is entirely positioned and fixed by screwing and fastening a bolt 98, which is inserted through the penetration hole 89fa, into a threaded hole 92a previously formed in the upper stand 92.

The fixed anvil 27a has a plurality of bolt holes 27aa formed at intervals in the rotor axial direction (direction vertical to the drawing sheet in FIG. 5), and is fixed to the fixed anvil mount portion 89d by screwing, into the bolt holes 27aa, bolts 99 inserted through a plurality of penetration holes 89da formed in the fixed anvil mount portion 89d at intervals in the rotor axial direction.

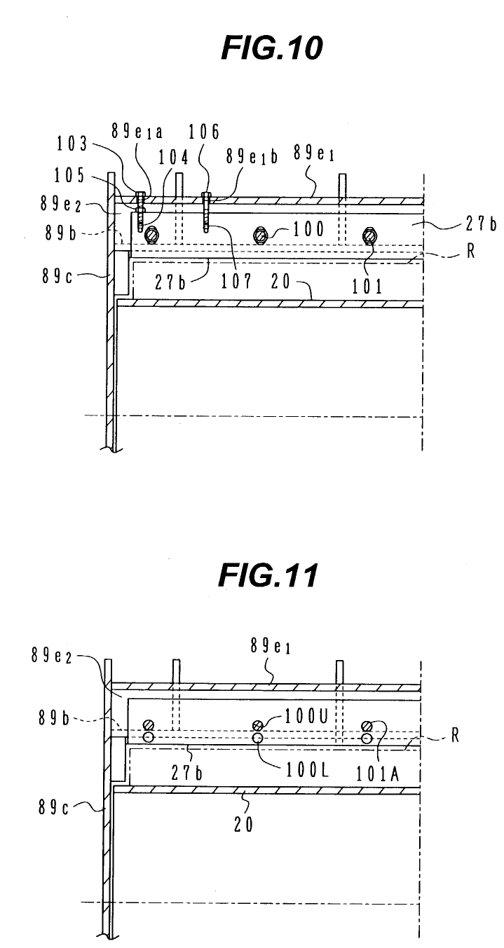

FIG. 10 is a transverse sectional view, taken along a section X-X in FIG. 5, showing a detailed structure of a part of the fixed blade support 89, i.e., the variable anvil accommodating portion 89e for accommodating the variable anvil 27b. Note that since the variable anvil accommodating portion 89e for accommodating the variable anvil 27c is of a similar structure, those two variable anvil accommodating portions will be described below with reference to FIG. 10.

Referring to FIG. 10 as well as FIG. 5, the variable anvil accommodating portion 89e is formed to have a dead-end space for accommodating the variable anvil 27b or 27c therein, and comprises a closure plate 89e1 positioned at an outermost periphery of the variable anvil accommodating portion 89e in the radial direction (corresponding to the bottom of the dead-end space), and an upper wall 89e2 and a lower wall 89e3 positioned upstream and downstream of the closure plate 89e1 in the rotating direction of the crushing rotor 20, respectively. The variable anvil 27b or 27c is accommodated in the dead-end space formed by the closure plate 89e1, the upper wall 89e2 and the lower wall 89e3 in such a manner that it is slidable in the direction normal to the crushing rotor 20.

Numeral 100 denotes an elongate penetration hole formed in the variable anvil in plural positions at intervals in the rotor axial direction (left-to-right direction in FIG. 10). By inserting bolts 101, which are inserted through penetration holes 89e2a and 89e3a formed respectively in the upper wall 89e2 and the lower wall 89e3 at an interval in the rotor circumferential direction (direction vertical to the drawing sheet in FIG. 10), into the elongate penetration holes 100, and then fastening nuts 102 over the bolts 101, the variable anvil 27b or 27c is accommodated and held in the variable anvil accommodating portion 89e (i.e., it is prevented from slipping off to the rotor 20 side) by engagement between the elongate penetration holes 100 and the bolts 101.

Numeral 103 denotes a bolt for setting an initial position of the variable anvil, which is screwed into a threaded hole 104 formed in the variable anvil 27b or 27c through a penetration hole 89e1a formed in the closure plate 89e1. Numeral 105 is a nut screwed over the bolt 103 for setting the initial position of the variable anvil. Further, numeral 106 denotes a bolt for moving the variable anvil back and forth, which is screwed into a threaded hole 107 formed in the variable anvil 27b or 27c through a penetration hole 89e1b formed in the closure plate 89e1.

The procedures for operation of moving back-and-forth and positioning the variable anvil 27b or 27c using the bolt 103, the nut 105 and the bolt 106 will be described later.

In the above construction, comparing with terms used in claims, the carrier conveyor 3 constitutes feeding means installed on one side of the body frame in its longitudinal direction to extend in the longitudinal direction of the body frame and feeding the wood to be crushed to the crusher. The travel devices 11 constitute traveling means provided on both sides of the body frame in the widthwise direction.

Also, the pressing conveyor support mechanism 55 constitutes a mechanism for up and down movably supporting the pressing conveyor, and the pressing conveyor hydraulic motors 49 constitute driving means for rotationally driving the pressing conveyor.

Further, the fixed anvil 27a constitutes a first fixed blade disposed on the fixed blade support that is provided around the crushing rotor, and the variable anvil 27b or 27c constitutes a second fixed blade disposed on the fixed blade support, which is provided around the crushing rotor, in a back-and-forth adjustable or replaceable manner. Those fixed anvil 27a and the variable anvil 27b or 27c constitute a fixed blade disposed on the fixed blade support, which is provided around the crushing rotor, in a back-and-forth adjustable or replaceable manner.

The operation of the one embodiment of the self-propelling wood crushing machine of the present invention thus constructed will be described below.

1-(I) Traveling

When traveling the self-propelling wood crushing machine in the automotive mode, the operator operates left and right control levers 108a, 109a in the cab 77, whereupon the left and right travel control valves (not shown) are shifted for supplying the hydraulic fluid from the hydraulic pump (not shown) to the left and right travel hydraulic motors 14L, 14R through the left and right travel control valves (not shown). The endless tracks 13 are thereby driven to move the travel devices 11 forward or backward.

1-(II) Crushing Work

In crushing work, the operator pushes in sequence a magnetic separator startup switch (not shown), a carrying-out conveyor startup switch (not shown), a crusher startup switch (not shown), a pressing conveyor startup switch (not shown), and a carrier conveyor startup switch (not shown), which are disposed on, e.g., a control panel provided in the cab 77, whereby respective operation signals are outputted as driving signals through a controller (not shown). Those driving signals are inputted to a magnetic separator control valve (not shown), a carrying-out conveyor control valve (not shown), a crusher control valve (not shown), a pressing conveyor control valve (not shown), and a carrier conveyor control valve (not shown), whereby those control valves are shifted. Responsively, the hydraulic fluid from the hydraulic pump is supplied to the corresponding hydraulic actuators (the magnetic separator hydraulic motor 75, a carrying-out conveyor hydraulic motor 68, the crusher hydraulic motors 24, the pressing conveyor hydraulic motors 49, and the carrier conveyor hydraulic motor 39) through the respective control valves for driving those hydraulic motors.

As a result, the magnetic separator hydraulic motor 75 drives the magnetic separator belt 74 to rotate about the magnetic force generating means (not shown), the carrying-out conveyor hydraulic motor 68 drives the conveyor belt 69 for circulation, and the crusher hydraulic motors 24, 24 drive the rotary shaft 20a of the crushing rotor 20 to rotate the crushing rotor 20 at high speed. The pressing conveyor hydraulic motors 49 drive the feeding belt 44 through the drive roller 43 for circulation, and the carrier conveyor hydraulic motor 39 drives the feeding belt 31 through the feed roller 29 for circulation.

In that way, the magnetic separator 8, the carrying-out conveyor 7, the crusher 16, the pressing conveyor 5, and the carrier conveyor 3 are started up. When materials to be crushed (such as wood to be crushed) are loaded into the hopper 2 using working equipment, if necessary, or manually (man power) in the above condition, the materials received in the hopper 2 are placed on the feed plates 48 of the feeding belt 31 of the carrier conveyor 3 and then fed substantially horizontally toward the rear side of the self-propelling wood crushing machine while being guided by the side walls 2b of the hopper 2.

When the materials to be crushed are fed to the rear side and reach the vicinity of the front end of the pressing conveyor 5, they are taken into the pressing conveyor 5 such that the materials on the upper side come under the feeding belt 44 of the pressing conveyor 5 and are pressed by the dead weight of the pressing conveyor 5 to be gripped between the pressing conveyor 5 and the carrier conveyor 3. With the rotation of the feeding belt 44, the materials are carried toward the rear side and introduced to the crusher 16 under cooperation with the carrier conveyor 3 while being gripped between the two conveyors. In this connection, the hydraulic cylinder 57 is extended and contracted only for maintenance to forcibly move the slider 58 in the vertical direction as a basic function. During the crushing work, the hydraulic cylinder 57 is not operated for up and down moving the slider 58 (although it performs the damper function of suppressing abrupt vertical movements), and the pressing conveyor 5 presses and grips the materials to be crushed under the action of only the dead weight thereof.

When the materials to be crushed are introduced to the crusher 16, the materials are sandwiched from above and below under cooperation of the pressing roller 42 provided at the end of the pressing conveyor 5 closer to the crusher 16 and the feed roller 29 provided at the end of the carrier conveyor 3 closer to the crusher 16, and distal end portions of the materials closer to the crusher 16 than portions sandwiched between the two rolls 42, 29 are projected toward the crushing rotor 20 in a cantilevered state such that the sandwiched portions of the materials serve as a fulcrum for the crushing. Then, the rotating crushing bits 18 of the crushing rotor 20 hit against the projected distal end portions of the materials to relatively roughly break off or crush them (primary crushing, preliminary crushing).

The broken-off distal end portions of the materials are introduced to move in the rotating direction of the crushing rotor 20 in a space along the outer periphery of the crushing rotor 20, and then successively hit against the anvils 27a, 27b and 27c for further crushing into smaller pieces by impact forces (secondary crushing, main crushing). The wood pieces crushed in that way continue rotating in the space along the outer periphery of the crushing rotor 20 and are still further crushed by the impact forces applied from the crushing bits 18 and the anvils 27a, 27b and 27c until the sizes of the crushed wood pieces are reduced to such an extent as enough to pass through the openings of the sieving member 26. The crushed wood pieces having sizes reduced to such an extent as enough to pass through the openings of the sieving member 26 are separated by passing through the openings and are then ejected to the exterior of the sieving member 26.

The ejected crushed wood pieces are dropped on the conveyor belt 69 of the carrying-out conveyor 7 through a chute 83 (see FIG. 3(a)). The circulating conveyor belt 69 of the carrying-out conveyor 7 transports the crushed wood pieces toward the rear side and finally delivers the crushed wood pieces as recycled materials to the side on the back of the self-propelling wood crushing machine.

On that occasion, the magnetic separator 8 causes magnetic forces generated from the magnetic force generating means to act on the crushed wood pieces, which are being transported by the carrying-out conveyor 7, through the rotating belt 74 of the magnetic separator for attracting magnetic materials on the conveyor belt 69 to the magnetic separator belt 74. The attracted magnetic materials are carried in a direction substantially perpendicular to the conveyor belt 69 (widthwise direction of the self-propelling wood crushing machine) and are dropped laterally of the conveyor belt 69 for delivery through a chute (not shown) provided on the frame 66 of the carrying-out conveyor 7.

1-(III) Operation of Moving Variable Anvil Back-and-Forth

In this embodiment, as described above, the crushing bits 18 of the crushing rotor 20 are caused to hit against the materials to be crushed for crushing them (primary crushing). Then, the crushed pieces successively hit against the anvils 27a, 27b and 27c, which serve as the fixed blades provided around the crushing rotor 20 on the downstream side in the rotor rotating direction, for further crushing (secondary crushing). When the crushed pieces are crushed into smaller pieces than the area of the plural openings of the sieving member 26 provided around the crushing rotor 20, the smaller crushed pieces are ejected to the exterior through the openings.

On that occasion, the sizes of the crushed pieces after being crushed by the anvils 27a, 27b and 27c depend on the gaps between the blades of the anvils 27a, 27b, 27c and the crushing rotor 20 (more precisely, the gap sizes between the anvils 27a, 27b, 27c and the locus R of rotation of the crushing bits 18). In this embodiment, as described above, the two variable anvils 27b, 27c are movable toward and away from the crushing rotor 20. The operation of moving the two variable anvils 27b, 27c toward and away from the crushing rotor 20 and the operation of setting the anvil initial positions prior to the former operation will be described below in order.

First, before starting the crushing work in above (1-II), the initial positions of the variable anvils 27b, 27c are each set using the initial position setting bolt 103. More specifically, in a state where the anvil moving bolt 106 is sufficiently loosened or removed, the anvil 27b or 27c is moved closer to the rotor 20 side by rotating the initial position setting bolt 103 while holding the head of the bolt 103 abutted against the closure plate 89e1. When the anvil 27b or 27c reaches just the locus R of rotation of the crushing bits 18 (or a position just before the locus R), the nut 105 screwed over the bolt 103 is fastened to set the relative positional relationship between the bolt 103 and the anvil 27b or 27c as obtained when the locus R of rotation is substantially reached. By thus setting the initial position (initial movable range, limit of allowable movement closest to the rotor), it is possible to prevent at least the anvils 27b, 27c from entering the inside of the locus R of rotation and strongly contacting the crushing bits 18 to break them when the crushing work is subsequently started.

Upon the completion of the above-described initial position setting, the anvil moving bolt 106 is rotated clockwise or counterclockwise as required (after newly attaching the bolt 106 when it has been removed), causing the anvil 27b or 27c to move toward or away from the side of the crushing rotor 20. As a result, the gap size between each of the anvils 27b, 27c and the locus R of rotation of the crushing bits 18 of the crushing rotor 20 can be set as required.

The self-propelling wood crushing machine of this embodiment having the above-described construction can provide advantages given below.

1-(1) Advantages due to Equipment Layout Positions

In the self-propelling wood crushing machine of this embodiment, the various units of equipment, such as the travel devices 11, the crushing unit 4, the carrier conveyor 3, the pressing conveyor 5, the carrying-out conveyor 7, and the hydraulic actuators for driving those driven members (i.e., the left and right travel hydraulic motors 14L, 14R, the crusher hydraulic motors 24, the carrier conveyor hydraulic motor 39, the pressing conveyor hydraulic motors 49, and the carrying-out conveyor hydraulic motor 68), as well as the power unit 9 as the driving source for those hydraulic actuators, are disposed in concentrated and well-balanced layout on the front side, the rear side, the center and the underside of the body frame 10. By efficiently arranging those components without wasteful use of spaces, the entire size of the self-propelling wood crushing machine can be reduced. Consequently, a recent demand for size reduction can be satisfactorily coped with, which has arisen from, e.g., a difficulty in securing the wood crushing plant site, a narrower area of the plant site, and a standpoint of transport routes.

Further, with the so-called front-inlet and rear-outlet structure that the carrier conveyor 3 and the carrying-out conveyor 7 are arranged respectively on the front side and the rear side, the wood to be crushed can be arranged for loading to locate from the hopper 2 and the carrier conveyor 3 to any of three directions toward the front, right and left side of the self-propelling wood crushing machine, and the crushed wood pieces can be carried out to a place remote from the wood to be crushed. Accordingly, the degree of freedom in layout of the self-propelling wood crushing machine in the work site can be increased.

1-(2) Advantages Due to Back-and-Forth Movement of Variable Anvil

With this embodiment, since the two variable anvils 27b, 27c are movable toward and away from the crushing rotor 20 to change the gap size therebetween as required, the size of the pieces crushed by the variable anvils 27b, 27c can be adjusted to a desired value. When adjusting the size of the crushed pieces to a desired value regardless of either a smaller or larger size side, therefore, the crushed pieces adjusted so as to fall within a desired size range can be obtained while maintaining good crushing efficiency by replacing the sieving member 26 with another one having openings of which area corresponds to the desired piece size and adjusting the gap size of the variable anvil 27b, 27c relative to the crushing rotor 20 to a value corresponding to the desired piece size.

Further, since the materials can be crushed into small pieces close to the final desired piece size on the side of the variable anvils 27b, 27c before being separated by the sieving member 26, the occurrence of clogging and shorter-period wear-out of the sieving member can be reduced in comparison with a conventional structure of adjusting the piece size only by replacing the sieving member while the anvils (fixed blades) are kept stationary.

Moreover, by moving the variable anvils 27b, 27c such that the gap sizes between the anvils 27a, 27b, 27c and the locus R of rotation of the crushing bits 18 are gradually reduced in the rotating direction of the crushing rotor 20 (i.e., such that the gap for the anvil 27b is smaller than the gap for the anvil 27a and the gap for the anvil 27c is smaller than the gap for the anvil 27b), the materials can be crushed into pieces gradually decreasing in size in multiple stages (three stages in this embodiment) and hence the crushing efficiency can be further improved.

1-(3) Others

1-\mathring{1} Advantages Due to Full Hydraulic System

In this embodiment, the various actuators (such as the carrier conveyor hydraulic motor 39, the pressing conveyor hydraulic motors 49, the crusher hydraulic motors 24, the carrying-out conveyor hydraulic motor 68, the magnetic separator hydraulic motor 75, the left and right travel hydraulic motors 14L, 14R, and the hydraulic cylinder 57 for up and down moving the pressing conveyor) of the self-propelling wood crushing machine are constructed as a full hydraulic drive system employing the engine as a driving source. In a system in which the crushing rotor 20 is directly coupled to the engine through a clutch, for example, a large-sized hydraulic source (such as a large-sized hydraulic pump) is separately required for the left and right travel hydraulic motors 14L, 14R. In the full hydraulic drive system of this embodiment, however, a hydraulic source (hydraulic pump) can be shared by the left and right travel hydraulic motors 14L, 14R and the crusher hydraulic motors 24, which require an especially large-sized hydraulic source among the various hydraulic actuators. As a result, the driving mechanism can be simplified.

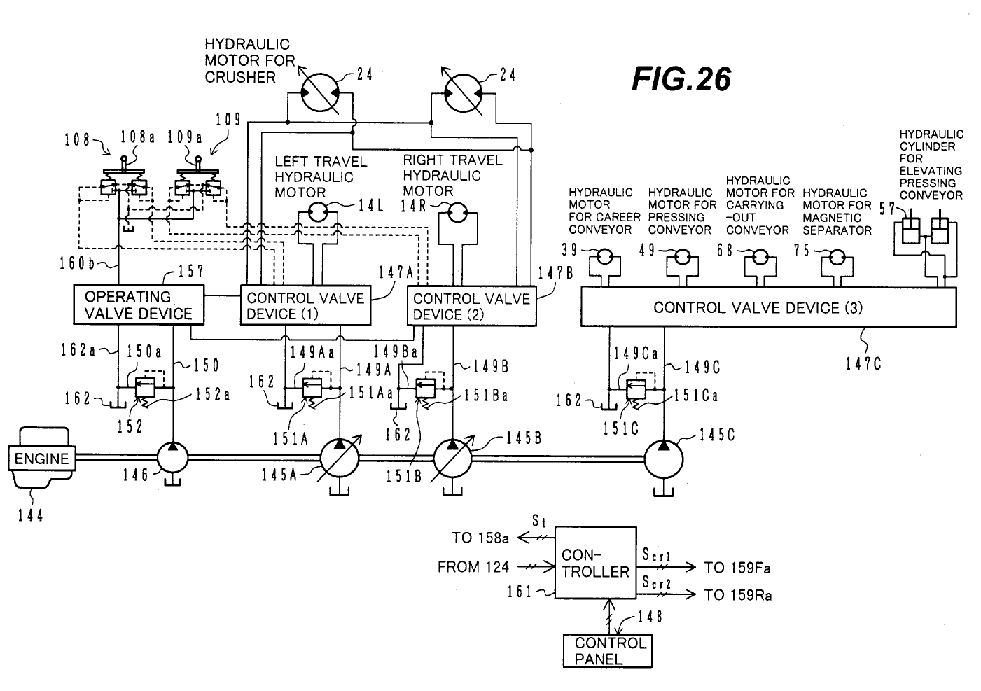

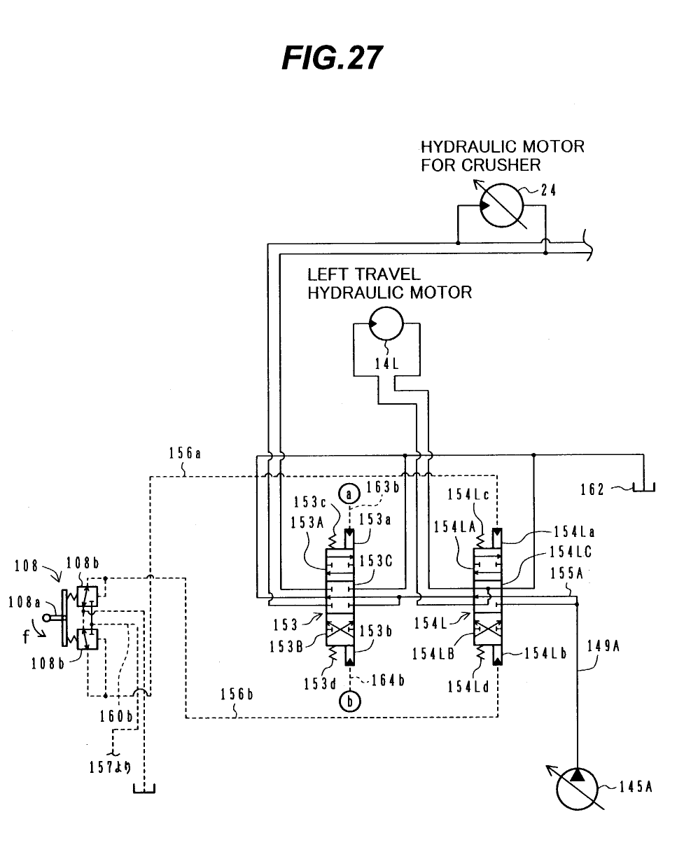

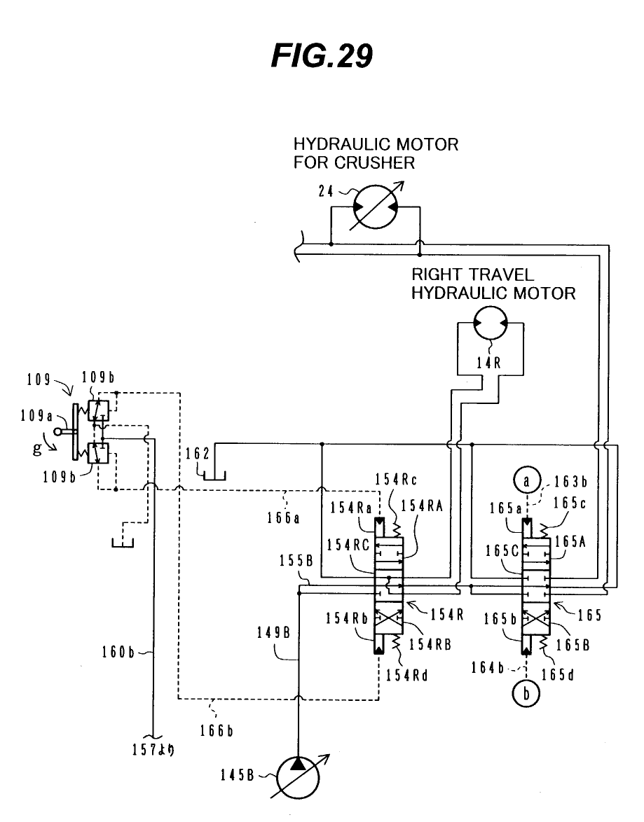

Also, in the engine directly-coupled system, there is a possibility that the engine may stall if the crushing rotor is subjected to overload. On the other hand, in the full hydraulic drive system of this embodiment, if the crushing rotor 20 is subjected to overload, the engine can be prevented from undergoing overload and from stalling by, for example, reducing the engine revolution speed or operating a relief valve (see, e.g., relief valves 151A, 151B in FIG. 26 described later). Moreover, it is general that when the crushing rotor 20 is subjected to overload, the crushing rotor 20 is driven backward. In the engine directly-coupled system, a complicated gear mechanism is required to drive the crushing rotor backward. By contrast, in the full hydraulic drive system of this embodiment, the crushing rotor 20 can be driven backward by shifting control valves (see, e.g., a first crusher control valve 153 in FIG. 27 and a second crusher control valve 165 in FIG. 29), and hence the driving mechanism can be simplified.

Furthermore, in the engine directly-coupled system, since the crushing rotor is directly coupled to the engine through the clutch, the engine and the crusher cannot be disconnected. In this embodiment, however, the components around the engine and the crusher can be separated into respective units as with the power unit 9 and the crushing unit 4. Therefore, the surroundings of the crusher can be covered by enclosing the crushing unit 4 with a cover, which can prevent scattering of the small crushed pieces produced during the crushing work. Similarly, the surroundings of the engine can be covered by enclosing the power unit 9 with a cover, which can prevent such an event that the small crushed pieces produced from the crusher are ignited in an engine area generating intense heat. Additionally, since the control valves for the various hydraulic actuators, etc. can be enclosed in the power unit 9 together with the engine, it is possible to prevent a failure in operation of the control valves, which may occur upon biting of sand, dust, the crushed pieces, etc. produced the work site of the self-propelling wood crushing machine into the control valves. Hence, the durability of the self-propelling wood crushing machine against environments can be improved.

With the separation into the respective units, the case of requiring larger power for the crusher, for example, can also be adapted by replacing the power unit with a new one by removing and attaching hydraulic hoses and mount bolts.

1-\mathring{2} Advantages Due to Vertical Movement of Pressing Conveyor

In this embodiment, the pressing conveyor 5 can be up and down moved by extending and contracting the hydraulic cylinder 57 of the pressing conveyor support mechanism 55. With that feature, a portion of the wood to be crushed (serving as a fulcrum for the crushing) sandwiched between the pressing conveyor 5 and the carrier conveyor 3, which is subjected to maximum forces during the crushing of the wood to be crushed, is not moved in the horizontal direction. Therefore, an area where large forces act can be reduced in comparison with the above-described conventional structure in which the pressing roller swings so as to move farther away from the crushing rotor as the pressing roller rotates upward, and the fulcrum for the crushing is moved in the horizontal direction. Thus, this embodiment is superior in point of strength design. Another advantage is that since the pressing conveyor 5 is up and down movable, a shift from the forward rotation to the backward rotation can be relatively smoothly performed, for example, when the carrier conveyor 3 and the pressing conveyor 5 are driven to rotate backward under a high load while driving the crushing rotor to rotate backward.

1-\mathring{3} Advantages Due to Smaller Diameter of Pressing roller

The size of the crushed pieces after the primary crushing by the crushing bits 18 of the crushing rotor 20 depends on the distance between the fulcrum for the crushing defined by the pressing roller 42 of the pressing conveyor 5 and the crushing rotor 20. Therefore, when the distance between the fulcrum for the crushing and the crushing rotor 20 is relatively large, the size of the crushed pieces after the primary crushing is also relatively large. Then, those crushed pieces continue rotating around the crushing rotor 20 plural times until the size of the crushed pieces is reduced to such an extent as enough to pass through the sieving member 26, thus resulting in poor efficiency. According to this embodiment, with the structure that the pressing conveyor hydraulic motors 49 for the pressing conveyor 5 are disposed on the drive roller 43 side as described above, the diameter of the pressing roller 42 can be reduced. As compared with the conventional structure in which the pressing roller has a relatively large diameter, therefore, the distance between the pressing roller 42 and the crushing rotor 20 can be reduced. Hence, the size of the crushed pieces after the primary crushing can be reduced and the crushing efficiency can be improved. Further, in this embodiment, the pressing conveyor 5 is up and down movable as described above. As compared with the conventional structure in which the pressing roller swings and moves farther away from the crushing rotor as the pressing roller rotates upward, therefore, the distance between the fulcrum for the crushing and the crushing rotor 20 can be kept relatively small even when large-sized wood to be crushed is pressed. As a result, the crushing efficiency can be surely improved.

Note that the present invention is not limited to the embodiment described above with reference to FIGS. 1 to 10, and various modifications can be made on the present invention without departing from the gist and technical concept of the present invention. Those modifications will be described below.

[1] Gap Adjusting Structure with Change of Mount Position

FIG. 11 is a transverse sectional view showing a detailed structure of the variable anvil accommodating portion 89e for accommodating the variable anvil 27b according to one modification, and corresponds to FIG. 10 representing the one embodiment of the present invention. In FIG. 11, components similar to those in FIG. 10 are denoted by the same numerals. Also, the variable anvil accommodating portion 89e for accommodating the variable anvil 27c has a similar structure to that in FIG. 10.

Referring to FIG. 11, in this modification, the mount position of each variable anvil 27b, 27c is changed in plural stages (two stages in this modification) by selectively inserting an anvil positioning bolt 101A into one of a plurality (two in this modification) of penetration holes 100U, 100L formed in the variable anvil 27b, 27c at intervals in the direction normal to the rotor without using the bolt 103 for setting the initial position of the variable anvil, the variable anvil moving bolt 106, etc. which are used in the one embodiment of the present invention.

More specifically, by inserting the bolt 101A, which is also inserted through the upper wall penetration hole 89e2a and the lower wall penetration hole 89e3a as described above, into the penetration hole 100U formed in the variable anvil 27b or 27c at a relatively outside position in the rotor radial direction and then positioning and fixing the bolt 101A with a nut 102, the gap distance to the locus R of rotation of the crushing bits can be set to a relatively small value as shown in FIG. 11. By inserting the bolt 101A into the penetration hole 100L formed at a relatively inside position in the rotor radial direction and then positioning and fixing the bolt 101A, the gap distance to the locus R of rotation of the crushing bits can be set to a relatively large value. Thus, since the gap distance to the locus R of rotation of the crushing bits can be adjusted by moving the variable anvil 27b, 27c toward and away from the rotor, this modification can also provide the similar advantage as that obtainable with the one embodiment of the present invention.

Instead of selectively inserting the bolt into one of a plurality of circular penetration holes formed in the variable anvil 27b, 27c at intervals in the direction normal to the rotor as described above, one hole elongate in the direction normal to the rotor may be formed in the variable anvil 27b, 27c and the position in the elongate hole, at which the bolt is inserted, may be displaced as required. This case can also adjust the gap distance from the variable anvil 27b, 27c to the locus R of rotation of the crushing bits as with the above embodiment, and therefore can provide the similar advantages.

[2] Structure Allowing Different Kinds of Anvils to be Extractably Attached

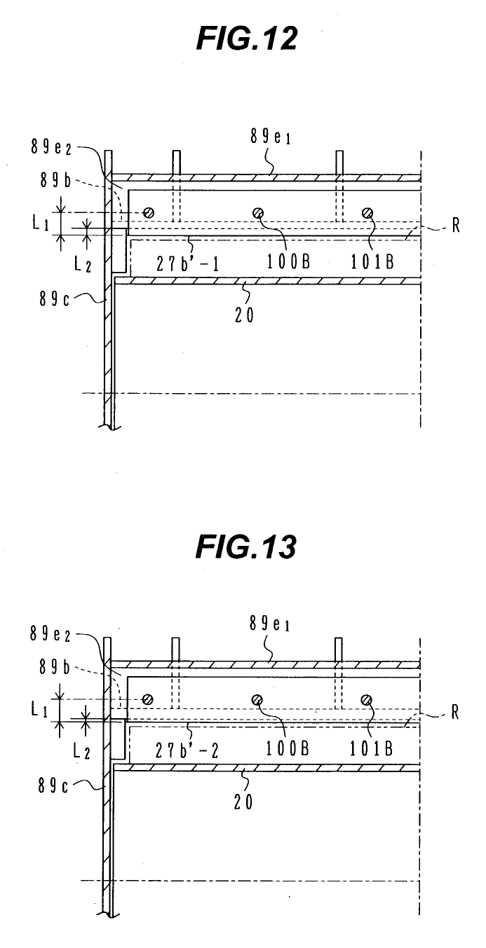

FIGS. 12 and 13 are transverse sectional views showing a detailed structure of the variable anvil accommodating portion 89e for accommodating the variable anvil 27b according to another modification, and corresponds to FIG. 10 representing the one embodiment of the present invention and FIG. 11 representing the modification [1]. Components similar to those in FIGS. 10 and 11 are denoted by the same numerals.

In this modification, a plurality (two in this modification) of variable anvils 27b′ having different lengths, by which the anvils protrude from the variable anvil accommodating portion 89e toward the crushing rotor 20 side, are prepared, and the gap distance to the locus R of rotation of the crushing bits is changed by extractably attaching one of those variable anvils 27b′.

FIG. 12 shows a state in which a variable anvil 27b′-1 having a relatively long distance L1 from the center of a penetration hole 100B, into which a bolt 101B is inserted, to its end on the side closer to the rotor and having a relatively large length L2 of its protruded portion is attached. In that state, the gap distance to the locus R of rotation of the crushing bits is relatively small. FIG. 13 shows a state in which a variable anvil 27b′-2 having a relatively short distance L1 from the center of the penetration hole 100B and having a relatively small length L2 of its protruded portion is attached. In that state, the gap distance to the locus R of rotation of the crushing bits is relatively large. Note that the variable anvil 27c also has the similar structure.

By replacing the detachable variable anvils 27b′-1, 27b′-2 as required, the gap distance to the locus R of rotation of the crushing bits can be adjusted. Accordingly, this modification can also provide the similar advantage as that obtainable with the one embodiment of the present invention.

[3] Structure Using Different Kinds of Fixed Blades (So-Called Counter Cutters)

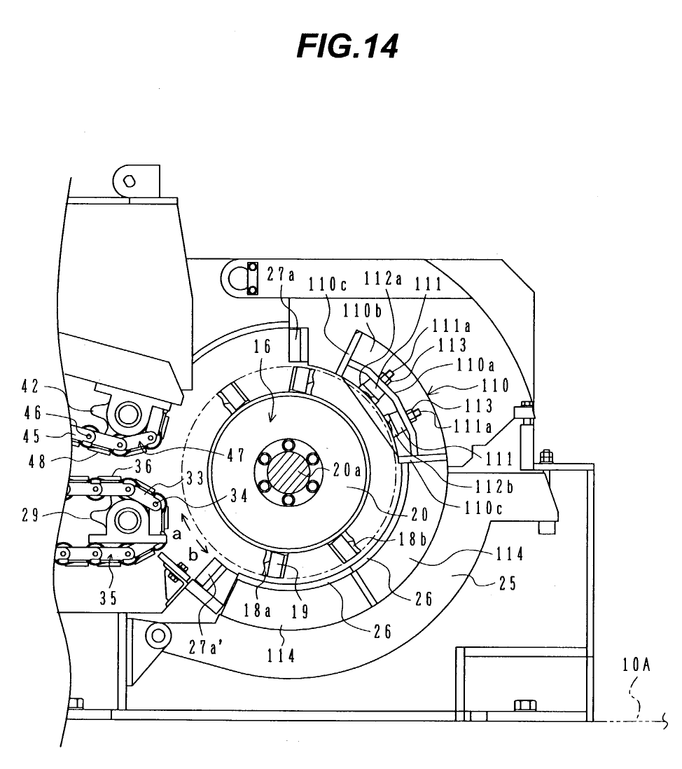

FIG. 14 is an enlarged side view showing a structure in the vicinity of the crushing unit in the self-propelling wood crushing machine according to a modification, and corresponds to FIG. 5 representing the one embodiment of the present invention. In FIG. 14, components similar to those in FIG. 5 are denoted by the same numerals.

Referring to FIG. 14, numeral 110 denotes a counter cutter provided around the crushing rotor 20 in the vicinity of a position corresponding to the position at which the variable anvil accommodating portion 89e is arranged in the above-described structure of the one embodiment of the present invention shown in FIG. 5. The counter cutter 110 comprises a crushing bit mount portion 110a extended in a bent shape substantially following the locus R of rotation of the crushing bits 18, side walls 110b, 110b provided at both ends of the crushing bit mount portion 110a in the rotor axial direction (direction vertical to the drawing sheet in FIG. 14), and partition walls 110c, 110c provided to extend in the rotor radial direction at both ends of the crushing bit mount portion 110a on the respective sides in the direction of forward rotation of the rotor (direction of arrow (a) in FIG. 14) and the direction of backward rotation.

The crushing bit mount portion 110a is provided in plural positions (two in this modification) in the rotor circumferential direction with crushing bits 112a, 112b, which have substantially the same structure as the crushing bits 18, through fixtures 111. Each of the fixtures 111 has a threaded portion 111a formed on its outer periphery. The crushing bit 112a or 112b is fixed to the crushing bit mount portion 110a by inserting the fixture 111 into a penetration hole (not shown) formed in the crushing bit mount portion 110a from the inner peripheral side toward the outer peripheral side to such an extent that the threaded portion 111a is projected on the outer peripheral side, and then fastening a nut 113 over the projected threaded portion 111a.

On that occasion, as shown in FIG. 14, the central position of the crushing bit mount portion 110a having the bent shape is offset upward with respect to the axis position of the crushing rotor 20 (i.e., the axis position of the rotary shaft 20a). As a result, the gap sizes between the crushing bits 112a, 112b and the locus R of rotation of the crushing bits 18 are set such that the crushing bit 112a provides a smaller gap size than the fixed anvil 27a, and the crushing bit 112b provides a smaller gap size than the crushing bits 112a. In other words, the three fixed blades 27a, 112a and 112b are disposed so as to provide gaps gradually decreasing toward the downstream side in the rotating direction of the crushing rotor 20.

While FIG. 14 shows the two crushing bits 112a, 112b as representative ones, it is needless to say that a plurality of crushing bits 112 are provided in a proper array in each of plural rows extending in the axial direction of the crushing rotor (direction vertical to the drawing sheet).

Numeral 114 denotes an intermediate member for supporting the sieving member 26 on the support member 25. The intermediate member 114 is disposed between the outer peripheral side of circumferentially two-split sieving members 26, 26 and the inner peripheral side of the support member 25. As shown in FIG. 14, the intermediate member 114 is formed to have a relatively large size in the rotor radial direction. Thus, of two intermediate members 114, 114 and the corresponding sieving members 26, 26 arranged in the circumferential direction, an assembly of each pair of the intermediate member 114 and the sieving member 26 has a size substantially equal to that of the counter cutter 110. The counter cutter 110 and the assembly 114, 26 are each extractably attached in place and is replaceable as required.

Additionally, in the modification of FIG. 14, the crushing rotor 20 is rotatable in opposite directions, i.e., the forward direction of arrow (a) in FIG. 14 and the backward direction of arrow (b). Correspondingly, there are two kinds of fixed anvils, i.e., the anvil 27a for the forward rotation and an anvil 27a′ for the backward rotation, and two kinds of crushing bits of the crushing rotor 20, i.e., crushing bits 18a for the forward rotation and crushing bits 18b for the backward rotation.

This modification can also provide the similar advantage as that obtainable with the one embodiment of the present invention and the modifications [1] and [2].

More specifically, since the counter cutter 110 is extractably attached in place as described above, the gap distance to the locus R of rotation of the crushing bits can be adjusted by preparing a plurality of counter cutters 110 having different shapes of crushing bit mount portions 110A beforehand and attaching one of the plural counter cutters 110 in a detachable manner for replacement with another. As a result, this modification can also provide the similar advantage as that obtainable with the one embodiment of the present invention.

The gap distance to the locus R of rotation can be adjusted by other methods than replacing the entirety of the counter cutter 110 as described above. For example, the counter cutter 110 may have a structure that the counter cutter can swing about a pivot point provided near its upper end with a known swing mechanism to move toward and away from the crushing rotor 20. With such a swing structure, the gap size between the crushing bits 112 and the locus R of rotation of the crushing bits can be adjusted as required. Alternatively, a spacer member (not shown) may be interposed, for example, between the fixture 111 and the crushing bit mount portion 110a. By replacing plural kinds of spacer members being different in thickness from one to another (or selectively interposing the spacer member) as required, the gap size between the crushing bits 112 and the locus R of rotation of the crushing bits can be adjusted as required while using the same counter cutter 110. This modification can also provide the similar advantage.

Further, in the above-described structure, three units, i.e., the counter cutter 110, one assembly 114, 26, and the other assembly 114, 26, arranged in sequence from the upstream side of the crushing rotor 20 in the rotating direction have substantially the same size. Those three units may be each disposed in desired one of three positions in the circumferential direction through, e.g., replacement or interchange. For example, instead of arranging the counter cutter 110, the one assembly 114, 26, and the other assembly 114, 26 in sequence from the upstream side (clockwise in FIG. 14) as shown in FIG. 14, the three units can be arranged depending on the crushing mode, the kind and usage of the crushed materials, etc. such that the one assembly 114, 26, the counter cutter 110, and the other assembly 114, 26 are arranged in sequence from the upstream side, or that the counter cutter 110, the assembly 114, 26, and the counter cutter 110 are arranged in sequence from the upstream side, or that the three units are each constituted as the assembly 114, 26. Particularly, in the case of arranging those three units to be adaptable for the backward rotation of the crushing rotor 20, the counter cutter 110, the one assembly 114, 26, and the other assembly 114, 26 can be arranged in sequence from the upstream side in the backward rotating direction (i.e., counterclockwise in FIG. 14 in this case).

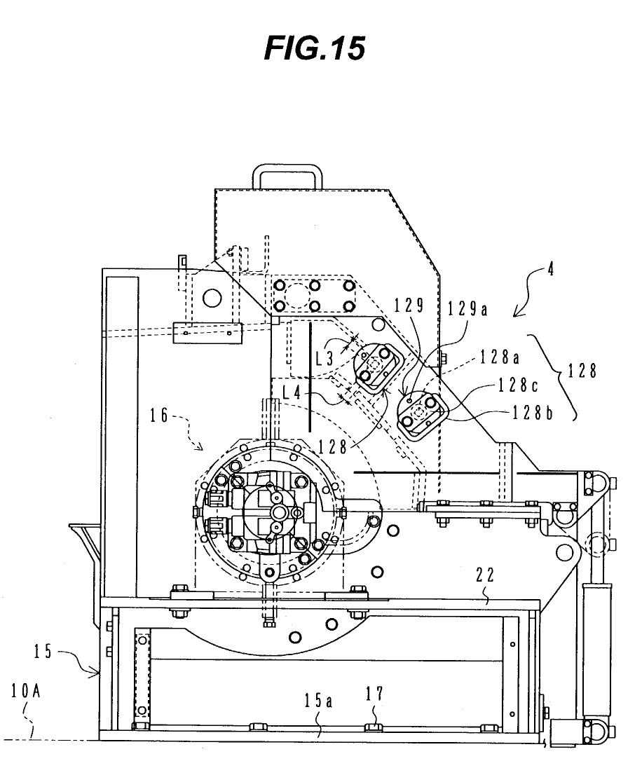

Next, another embodiment of the self-propelling wood crushing machine of the present invention will be described below with reference to FIGS. 15 to 30.

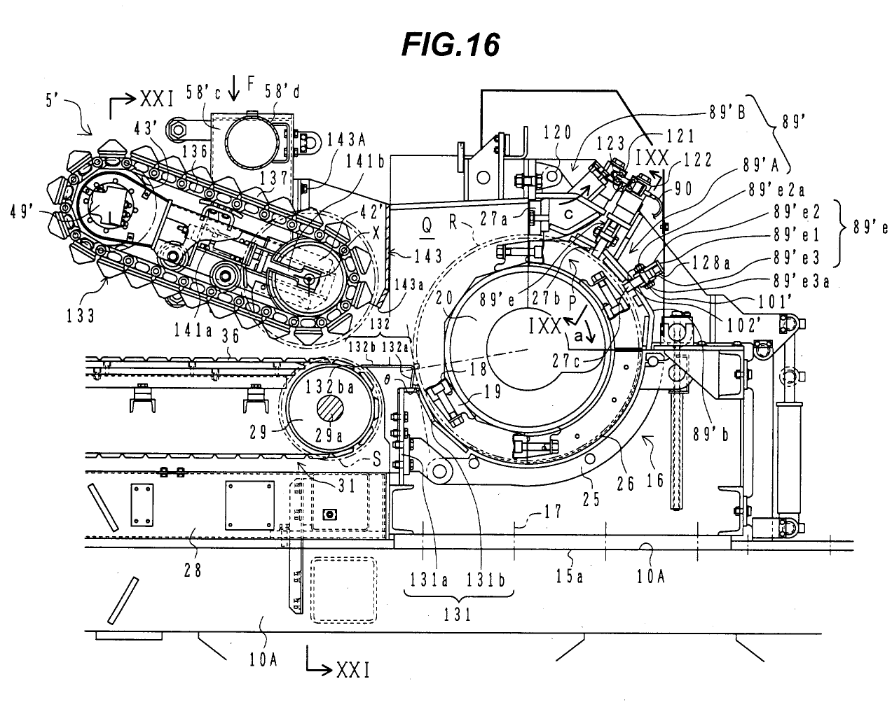

FIG. 15 is a partial enlarged side view showing a structure in the vicinity of a crushing unit 4 constituting another embodiment of the self-propelling wood crushing machine of the present invention, and FIG. 16 is a side view, partly seen through, of the structure shown in FIG. 15. FIGS. 15 and 16 correspond respectively to FIGS. 4 and 5 representing the one embodiment described above. In FIGS. 15 and 16, similar components to those in FIGS. 4 and 5 are denoted by the same numerals and a description thereof is omitted here.

Referring to FIGS. 15 and 16, a fixed blade support 89′ comprises a fixed portion 89′A fixed as a stationary side member to the base 15, and a rotatable portion 89′B provided above the fixed portion 89′A in a position near an uppermost (top) portion of the crushing motor 20 to be rotatable about a pin 120 with its axial direction extending substantially horizontally relative to the base 15. The fixed anvil 27a is provided in the rotatable portion 89′B, and the variable anvils 27b, 27c are provided in the fixed portion 89′A.

Shear pin supports 121, 122 are provided in an opposing relation, respectively, at an upper end of the rotatable portion 89′B closer to the fixed portion 89′A and an upper end of the fixed portion 89′A closer to the rotatable portion 89′B. Then, a shear pin 123 is disposed so as to bridge between the shear pin supports 121 and 122.

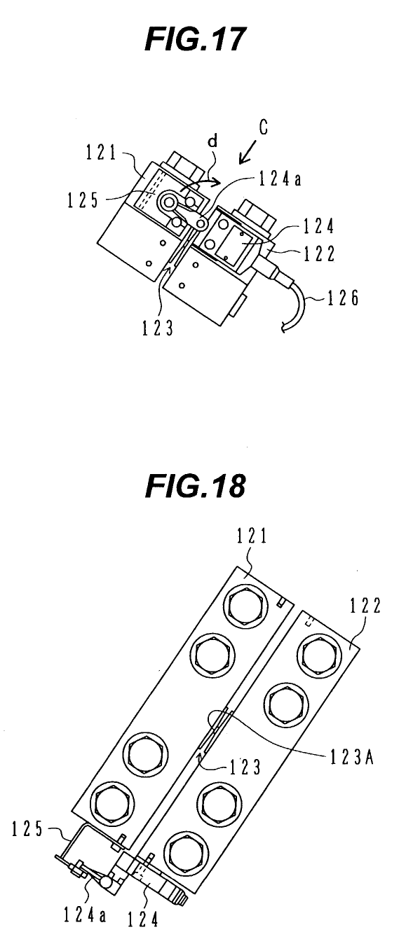

FIG. 17 is a partial enlarged view of an extracted part of FIG. 16, showing a detailed structure of the shear pin 123, and FIG. 18 is a plan view looking in the direction C in FIG. 17. Referring to FIGS. 17 and 18 as well as FIG. 16, the shear pin 123 is of the known type and includes a stress concentrated portion 123A constituted as, e.g., a cutout portion. The rotatable portion 89′B is freely rotatable about the pin 120, as described above, so that it is held stationary only when connected to the fixed portion 89′A through the shear pin 123. With such a structure, when an excessive force acts in the direction along the crushing rotor 20 upon the fixed anvil 27a disposed in the rotatable portion 89′B and exceeds a level endurable by the stress concentrated portion 123A of the shear pin 123, the shear pin 123 is broken off at the stress concentrated portion 123A, whereupon the rotatable portion 89′B is rotated about the pin 120 in the direction (c) in FIG. 16 (i.e., in the rotating direction of the crushing rotor 20) so as to be released from the excessive load. Accordingly, an opening is created in the position of the shear pin.

A known contact-type limit switch 124 is provided, as means for detecting the above-stated rotation of the rotatable portion 89′B, is disposed in the shear pin support 122 provided on the fixed portion 89′A side. In a normal state, a rotatable pin 124a of the limit switch 124 is locked by a lock member 125 projecting from the shear pin support 121. When the rotatable portion 89′B is rotated about the pin 120 as described above, the rotatable pin 124a is released from the state locked by the lock member 125 to rotate in the direction of arrow (d) in FIG. 17. This rotation of the rotatable pin 124a is electrically detected and outputted, as a detected signal, to a controller 161 (see FIG. 26 described later) via a cable 126.

Returning to FIG. 16, the fixed portion 89′A of the fixed blade support comprises an inner wall 89′b extended in a bent shape following the locus R of rotation of the crushing bits 18 as close as possible, and variable anvil accommodating portions 89′e, 89′e provided respectively in two positions that divide the inner wall 89′b into three parts in the circumferential surface.

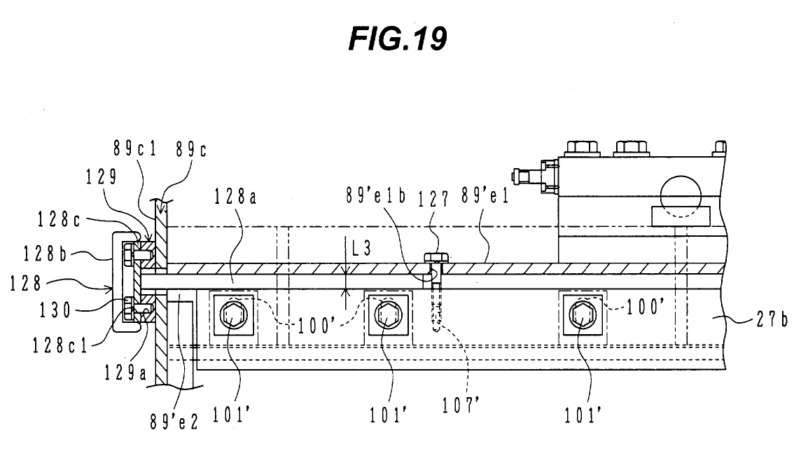

FIG. 19 is a transverse sectional view, taken along a section IXX-IXX in FIG. 16, showing a detailed structure of one of the variable anvil accommodating portions 89′e, 89′e, which accommodates the variable anvil 27b, and corresponds to FIG. 10 representing the one embodiment described above. Note that since the variable anvil accommodating portion 89′e for accommodating the variable anvil 27c is of the same structure, the two variable anvil accommodating portions will be described together with reference to FIG. 19.

Referring to FIG. 19 as well as FIG. 16, similarly to the variable anvil accommodating portions 89e in the one described of the present invention, the variable anvil accommodating portion 89′e is formed to have a dead-end space for accommodating the variable anvil 27b or 27c therein, and comprises a closure plate 89′e1 positioned at an outermost periphery of the variable anvil accommodating portion 89′e in the radial direction (corresponding to the bottom of the dead-end space), and an upper wall 89′e2 and a lower wall 89′e3 positioned upstream and downstream of the closure plate 89′e1 in the rotating direction of the crushing rotor 20, respectively. The variable anvil 27b or 27c is accommodated in the dead-end space formed by the closure plate 89′e1, the upper wall 89′e2 and the lower wall 89′e3 in such a manner that it is slidable in the direction normal to the crushing rotor.

Numeral 100′ denotes an elongate penetration hole formed in the variable anvil 27b or 27c in plural positions at intervals in the rotor axial direction (left-to-right direction in FIG. 19). By inserting bolts 101′, which are inserted through penetration holes 89′e2a and 89′e3a formed respectively in the upper wall 89′e2 and the lower wall 89′e3 at an interval in the rotor circumferential direction (direction vertical to the drawing sheet in FIG. 19), into the elongate penetration holes 100′, and then fastening nuts 102′ over the bolts 101′, the variable anvil 27b or 27c is accommodated and held in the variable anvil accommodating portion 89′e (i.e., it is prevented from slipping off to the rotor 20 side) by engagement between the elongate penetration holes 100′ and the bolts 101′.

Numeral 127 denotes a bolt for moving the variable anvil back and forth, which is screwed into a threaded hole 107′ formed in the variable anvil 27b or 27c through a penetration hole 89′e1b formed in the closure plate 89′e1.

Numeral 128 denotes a spacer member comprising an inserted portion 128a having a rectangular sectional shape and inserted between the closure plate 89′e1 and the variable anvil 27b or 27c, a grip portion 128b, and a connecting portion 128c for connecting the inserted portion 128a and the grip portion 128b. Also, numeral 129 denotes a ring-shaped spacer fixing plate that is fixed by welding, for example, to an outer peripheral surface 89c1 of one of the side walls 89c, 89c of the fixed blade support, which is positioned on the left side of the self-propelling wood crushing machine (left side in FIG. 19). A total of four threaded holes 129a, each pair of two holes being spaced in one of the direction normal to the crushing rotor 20 and a direction perpendicular to the normal direction), are formed in the spacer fixing plate 129 (see also FIG. 15).

The inserted portion 128a of the spacer member 128 is inserted between the closure plate 89′e1 and the variable anvil 27b or 27c externally of the side wall 89c, and the spacer member 128 is fixed to the fixed blade support 89 by fastening two spacer fixing bolts 130 into the threaded holes 129a of the spacer fixing plate 129 through penetration holes 128c1 that are formed in the connection portion 128c in two positions at both ends thereof. When the spacer fixing bolts 130, 130 are fastened into the threaded holes 129a, 129a formed in the spacer fixing plate 129 at an interval in the direction normal to the rotor as shown in FIGS. 15 and 19, the distance between the closure plate 89′e1 and the variable anvil 27b or 27c is given by a longer size L3 (see FIGS. 15 and 19) of the rectangular section of the inserted portion 128a. When the spacer fixing bolts 130, 130 are fastened into the threaded holes 129a, 129a formed in the spacer fixing plate 129 at an interval in the direction perpendicular to the direction normal to the rotor, the distance between the closure plate 89′e1 and the variable anvil 27b or 27c is given by a shorter size L4 (see FIG. 15) of the rectangular section of the inserted portion 128a.

The procedures for operation of moving the variable anvil 27b or 27c back and forth with the spacer member 128 will be described later.

On the other hand, referring to FIG. 16, a grate support structure 131 is provided in a wood material loading region of an area around the crushing outer diameter R at one end side of the grate 26 and the grate support 25 closer to the carrier conveyor 3 (left side in FIG. 16). The grate support structure 131 comprises a support stand 131a for supporting the grate support member 25, and a crushing chamber wall surface portion 131b positioned outside the crushing outer diameter R in the radial direction.

A guide plate member 132 having a substantially angled shape is disposed on the crushing chamber wall surface portion 131b. The guide plate member 132 comprises a crushed wood fly-out preventing portion 132a arranged to extend slightly obliquely with respect to the vertical direction, and a wood material introducing portion 132b arranged to lie substantially in the horizontal direction. More specifically, as shown in FIG. 16, the crushed wood fly-out preventing portion 132a is disposed such that the distance to the crushing outer diameter R is gradually reduced in the rotating direction (direction of arrow (a) in FIG. 16) of the crushing rotor 20, i.e., that it forms a predetermined angle θ (see FIG. 16) with respect to the direction tangential to the crushing outer diameter R. With such an arrangement, the crushed wood is suppressed from flying out as described later. The wood material introducing portion 132b is disposed such that its level in the height direction is lower than an uppermost (top) position of a locus S of rotation of the feed roller and its end 132ba on the side (left side in FIG. 16) closer to the feed roller 29 is positioned near the locus S of rotation of the feed roller 29.

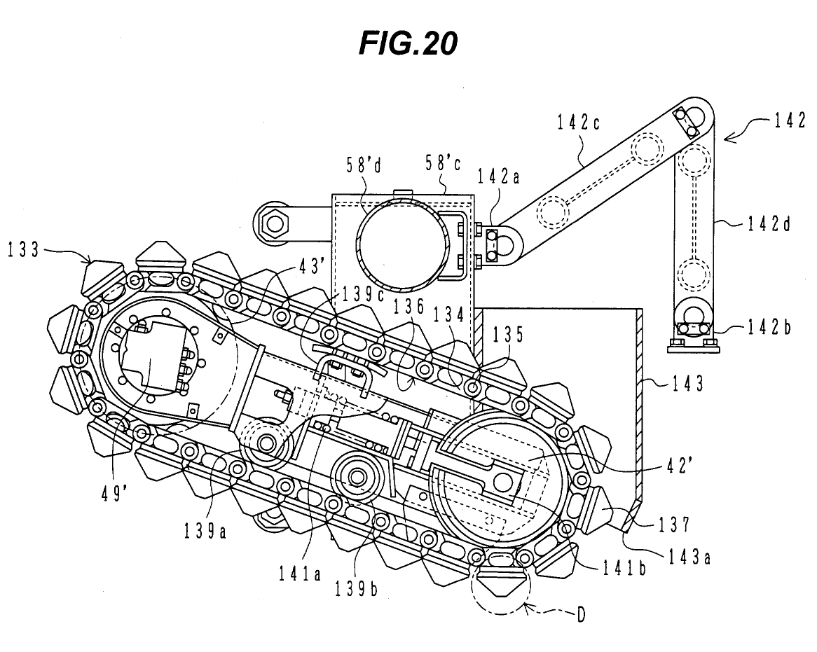

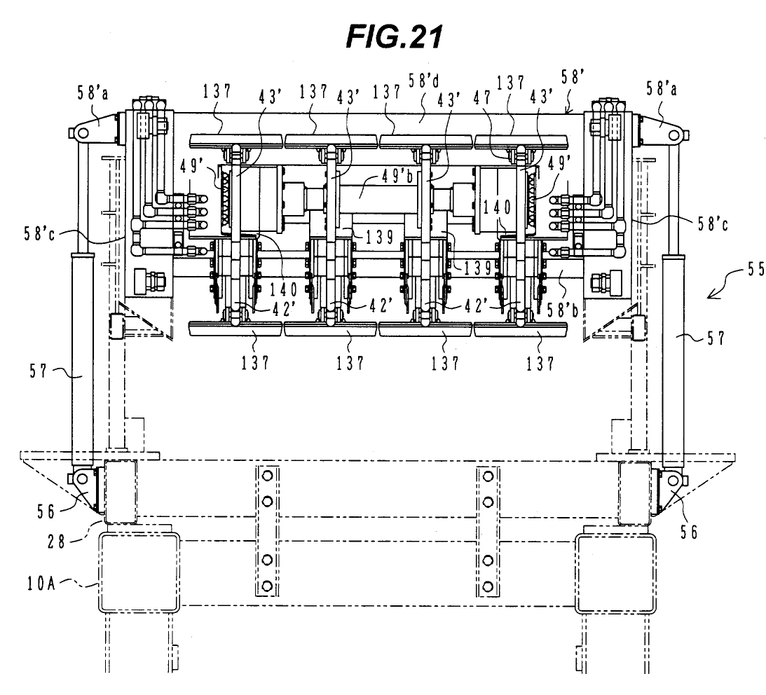

Further, referring to FIG. 16, as with the pressing conveyor 5 in the one embodiment of the present invention described above, a pressing conveyor 5′ is disposed above the end of the carrier conveyor 3 on the side closer to the crusher 16. FIG. 20 is a partial enlarged view of an extracted principal part of FIG. 16, showing a detailed structure of the pressing conveyor 5′, and FIG. 21 is a sectional view, partly broken away, taken along a section XXI-XXI in FIG. 16.

Referring to FIGS. 20 and 21, the pressing conveyor 5′ comprises a plurality (four in this embodiment) of pressing rollers 42′ being in the form of a sprocket having a diameter substantially equal to the feed roller 29 of the carrier conveyor 3 and provided above the carrier conveyor 3 in the vicinity of the crusher 16 (specifically at the end of the carrier conveyor 3 closer to the crusher 16), a plurality (four in this embodiment) of drive roller 43′ being in the form of a sprocket having a diameter substantially equal to the pressing roller 42′ and provided on the side opposite to the pressing roller 42′ (front side of the self-propelling wood crushing machine, the inlet side of the wood to be crushed), and plural rows (four in this embodiment) of feeding belts 133 extended between and wound around the drive roller 43′ and the pressing roller 42′, respectively.

Each of the feeding belts 133 comprises endless links 136 positioned at the center in the widthwise direction and made up of many link members 134 rotatably articulated between adjacent two through pins 135, and a plurality of pressing plates 137 arranged side by side in the feeding direction of the wood to be crushed and attached to the link members 134 in a one-to-one relation at an outer periphery of the endless link 136. In the four rows of feeding belts 133, though not clearly shown, the pressing plates 137 are arranged in the so-called zigzag pattern in which every adjacent pressing plates are shifted by ½ pitch relative to each other, for enhancing the capability of pressing and gripping the wood to be crushed.

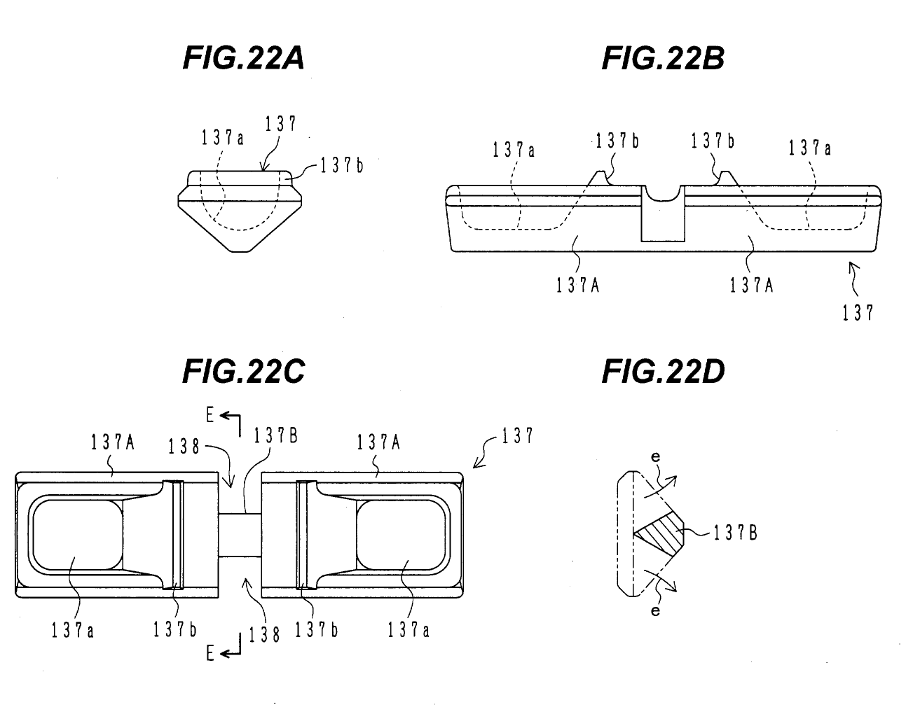

FIGS. 22(a) to 22(d) show a detailed structure of the pressing plate 137. Specifically, FIG. 22(a) is side view of the pressing plate 137 and corresponds to an enlarged view of a portion D in FIG. 20. FIG. 22(b) is a front view of the pressing plate 137, FIG. 22(c) is a plan view thereof, and FIG. 22(d) is a transverse sectional view taken along a section E-E in FIG. 22(c).

Referring to FIGS. 22(a) to 22(d), the pressing plate 137 has a substantially triangle transverse sectional shape (side shape) (namely, it is the so-called triangular shoe). The pressing plate 137 has left and right pressing portions 137A, 137A positioned at both left and right ends thereof in the widthwise direction (left-to-right direction in FIG. 22(b) or 22(c)). The pressing portions 137A, 137A have respective recesses 137a, 137a formed therein to face the inner peripheral side of the feeding belt 133. Left and right brackets 137b, 137b for attachment to the link member 134 are provided at ends of the recesses 137a, 137a on the side closer to the center in the widthwise direction.

The most important feature of the pressing plate 137 is that the pressing portions 137A, 137A are connected by a connecting portion 137B having a small transverse section in a substantially triangular shape, and openings 138 for preventing clogging of wood pieces are formed in a position corresponding to a mount portion of the link member 134 (in the vicinity of the brackets 137b). With that feature, wood pieces (crushed wood) coming into the inside of the feeding belt 133 can be expelled out to the exterior of the feeding belt 133 as indicated by arrows (e) in FIG. 22(d).

Returning to FIGS. 20 and 21, numeral 49′ denotes a pressing conveyor hydraulic motor contained and held on the radially inward side of each of the drive rollers 43′, 43′.

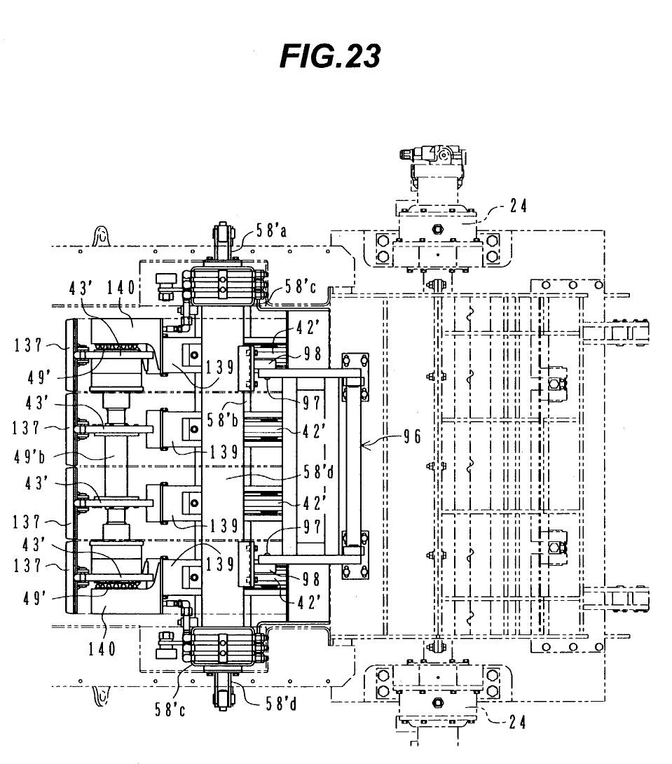

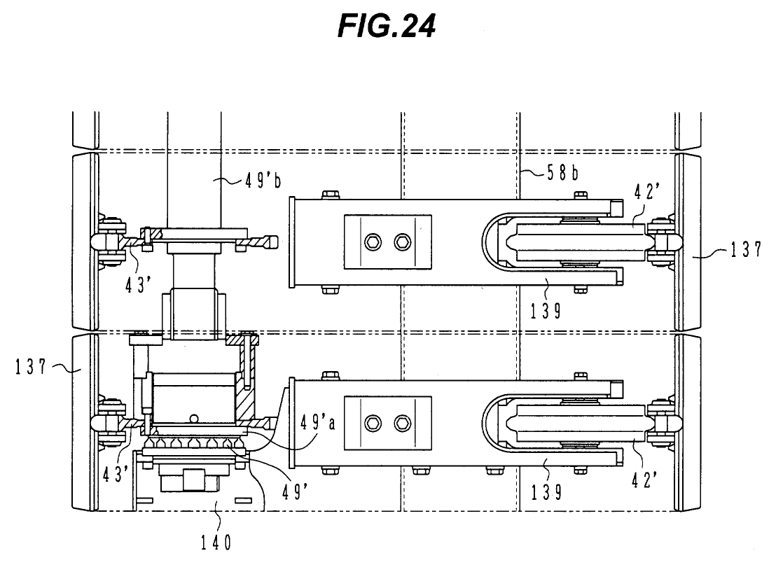

FIG. 23 is a plan view looking in the direction F in FIG. 16, and FIG. 24 is a partial enlarged view showing a detailed structure of the pressing conveyor hydraulic motors 49′ and thereabout in FIG. 23.

Referring to FIGS. 23 and 24, the pressing conveyor hydraulic motors 49′ are disposed on the inner side of the feeding belt 133 and fixed respectively to hydraulic motor support frames 140, 140 provided on two 139, 139 of four pressing roller support frames 139 mounted to a connecting beam 58′b of a slider 58′ described later, which are positioned at both ends in the widthwise direction of wood crushing machine. Then, two 43′, 43′ of the four sprocket-like drive rollers 43′, which are positioned at both ends in the widthwise direction of wood crushing machine, are fixed to larger-diameter driving force output portions 49′a, 49′a of the pressing conveyor hydraulic motors 49′, 49′. Intermediate two 43′, 43′ of the four drive rollers 43′ other than the two disposed at both the ends in the widthwise direction are fixed to a common drive shaft 49′b disposed so as to couple the two pressing conveyor hydraulic motor 49′, 49′.

On the other hand, the four sprocket-like pressing rollers 42′ are each supported at its rotary shaft (not shown) by a movable bearing 141b that is urged by the drive roller 43′ in the direction away from the drive roller 43′ through a spring 141a received in the pressing roller support frames 139. Stated otherwise, the pressing rollers 42′ are resiliently supported such that their rotary shafts are displaceable toward the drive roller 43′ side (i.e., the side opposite to the crusher 16).

Each of the four pressing roller support frames 139 has guide rollers 139a, 139b and a guide plate 139c provided respectively in lower and upper portions thereof for guiding circulation of the endless link 136.

The pressing conveyor 5′ thus constructed is provided in a up and down slidable manner using a pressing conveyor support mechanism 55′ as with the one embodiment of the present invention.

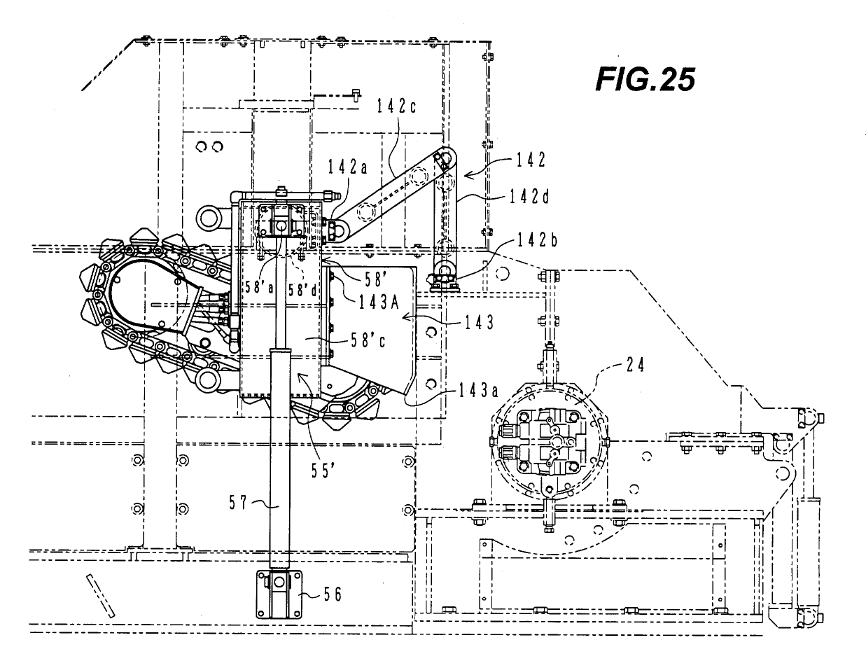

FIG. 25 is a side view showing an overall structure of the pressing conveyor support mechanism 55′. Referring to FIG. 25 as well as FIG. 21, the pressing conveyor support mechanism 55′ comprises a pair of left and right hydraulic cylinders 57, 57, and a slider 58′ provided at its left and right ends brackets 58′a connected to the other (upper) ends of the hydraulic cylinders 57, 57 and being up and down slidable upon extension and contraction of the hydraulic cylinders 57, 57.

The slider 58′ comprises, as with the one described of the present invention described above, the connecting beam 58′b disposed to extend substantially in the horizontal direction through the inside of the feeding belt 133, vertical beams 58′c, 58′c, the brackets 58′a, 58′a, and horizontal beams 58′d. Also, numeral 142 denotes a link-type guide member comprising a bracket 142a provided on the vertical beam 58′c, a bracket 142b provided on the upper stand 92 of the crusher unit 4, and link members 142c, 142d interconnecting the brackets 142a, 142b (see also FIG. 20). With such an arrangement, the link member 142 interconnects the slider vertical beam 58′c and the crusher upper stand 92 for guiding vertical movement of the pressing conveyor 5′ when the slider 58′ and the pressing conveyor 5′ are moved together up and down.

In addition, a wall 143 for preventing entanglement of crushed wood is fixed to lateral sides of the slider vertical beams 58′c, 58′c facing the crusher 16 by bolts 143A so that the wall 143 is also up and down movable together with the pressing conveyor 5′ upon operation of the pressing conveyor support mechanism 55′. The entanglement preventing wall 143 has a lower end 143a positioned at a level substantially the same as or lower than at least an axis position X (see FIG. 16) of the pressing roller 42′ so as to cover an upper half of the pressing conveyor 5′ at the end on the side closer to the crusher 16. With such an arrangement, the crushed wood is prevented from entangling into the pressing conveyor 5′ (described later in more detail).

A description is now made of stop control for the crusher 16 when the rotatable portion 89′B of the fixed blade support is rotated, which is one feature of this embodiment, while explaining a detailed construction of a hydraulic drive system equipped in the self-propelling wood crushing machine of this embodiment.

(a) Overall Construction

FIG. 26 is a hydraulic circuit diagram showing an overall schematic construction of a hydraulic drive system equipped in the self-propelling wood crushing machine of this embodiment.

Referring to FIG. 26, numeral 144 denotes an engine, and 145A, 145B and 145C denote, respectively, first and second variable displacement hydraulic pumps and a third fixed displacement hydraulic pump which are all driven by the engine 144. Numeral 146 denotes a fixed displacement pilot pump that is also driven by the engine 144. Numerals 14L, 14R, 24, 39, 49′, 57, 68 and 75 denote respective hydraulic actuators (i.e., left and right travel hydraulic motors, a crusher hydraulic motor, a carrier conveyor hydraulic motor, a pressing conveyor hydraulic motor, a hydraulic cylinder for up and down moving the pressing conveyor, a carrying-out conveyor hydraulic motor, and a magnetic separator hydraulic motor) which are supplied with hydraulic fluids delivered from the first, second and third hydraulic pumps 145A, 145B, 145C. Numerals 147A, 147B and 147C denote respectively first, second and third control valve devices including control valves 154L, 154R, 153, 165, etc. (described later in more detail) for controlling flow (directions and flow rates, or only flow rates) of the hydraulic fluids supplied from the first, second and third hydraulic pumps 145A, 145B, 145C to the respective hydraulic actuators 14L, 14R, 24, 39, 49′, 57, 68 and 75. Numerals 108a, 109a denote respectively left and right travel control levers disposed in the cab 77, as described above, for shifting a left travel control valve 154L (described later) in the first control valve device 147A and a right travel control valve 154R (described later) in the second control valve device 147B. A numeral 148 denotes a control panel disposed in the crusher body 1 (e.g., in the cab 77) for allowing an operator to enter commands and controlling, e.g., startup and stop of the carrier conveyor 3, the pressing conveyor 5′, the crusher 16, the carrying-out conveyor 7, and the magnetic separator 8.

Relief valves 151A, 151B, 151C and 152 are disposed respectively in lines 149Aa, 149Ba, 149Ca and 150a, which are branched from delivery lines 149A, 149B, 149C and 150 of the first, second and third hydraulic pumps 145A, 145B, 145C and the pilot pump 146. Relief pressure values for limiting maximum values of respective delivery pressures of the first, second and third hydraulic pumps 145A, 145B, 145C and the pilot pump 146 are set by urging forces of springs 151Aa, 151Ba, 151Ca and 152a disposed in the respective relief valves.

(b) First Control Valve Device and Operating Valve Device

FIG. 27 is a hydraulic circuit diagram showing a detailed construction of the first control valve device 147A. Referring to FIG. 27, the first crusher control valve 153 connected to the crusher hydraulic motor 24 and the left travel control valve 154L connected to the left travel hydraulic motor 14L are pilot-operated three-position selector valves capable of controlling the directions and flow rates of the hydraulic fluid supplied to the associated hydraulic motors 24, 14L.

The hydraulic fluid delivered from the first hydraulic pump 145A is introduced to both the left travel control valve 154L and the first crusher control valve 153, whereby the hydraulic fluid is supplied to the left travel hydraulic motor 14L and the crusher hydraulic motor 24. Those control valves 154L, 153 are arranged on a center bypass line 155A, which is connected to the delivery line 149A of the first hydraulic pump 145A, in the order of the left travel control valve 154L and the first crusher control valve 153 from the upstream side.

The left travel control valve 154L is operated by a pilot pressure that is generated from the pilot pump 146 and reduced to a predetermined pressure with the control lever 108a. More specifically, the control lever device 108 comprises the control lever 108a and a pair of pressure reducing valves 108b, 108b for outputting the pilot pressure depending on the amount by which the control lever 108a is operated. When the control lever 108a of the control lever device 108 is operated in the direction of arrow (f) in FIG. 27 (or in the opposite direction, the correspondent relation is equally applied to the following description), the pilot pressure is introduced to a driving sector 154La (or 154Lb) of the left travel control valve 154L through a pilot line 156a (or 156b), whereupon the left travel control valve 154L is shifted to an upper shift position 154LA (or a lower shift position 154LB) in FIG. 27. Then, the hydraulic fluid from the first hydraulic pump 145A is supplied to the left travel hydraulic motor 14L through the delivery line 149A, the center bypass line 155A, and the shift position 154LA (or the lower shift position 154LB) of the left travel control valve 154L, thereby driving the left travel hydraulic motor 14L to rotate in the forward direction (or in the backward direction).

When the control lever 82a is operated to a neutral position shown in FIG. 27, the left travel control valve 154L is returned to a neutral position 154LC, shown in FIG. 27, under balance between the urging forces of springs 154Lc, 154Ld, whereby the left travel hydraulic motor 14L is stopped.

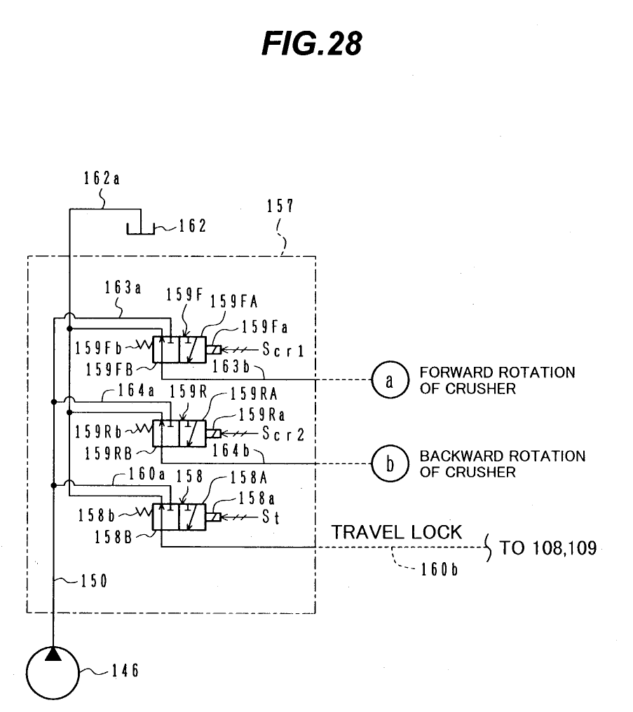

FIG. 28 is a hydraulic circuit diagram showing a detailed construction of the operating valve device 157. Referring to FIG. 28, a travel lock solenoid control valve 158, a crusher forward-rotation solenoid control valve 159F, and a crusher backward-rotation solenoid control valve 159R are connected in parallel to the delivery line 150.

The travel lock solenoid control valve 158, which is incorporated in the operating valve device 157, is disposed in pilot introducing lines 160a, 160b for introducing the pilot pressure from the pilot pump 146 to the control lever device 108 and is shifted by a drive signal St (described later) from the controller 161 (see FIG. 26).

More specifically, when the drive signal St inputted to a solenoid 158a is turned on, the travel lock solenoid control valve 158 is shifted to a communicating position 158A on the right side in FIG. 28, whereupon the pilot pressure from the pilot pump 146 is introduced to the control lever device 108 via the introducing lines 160a, 160b so that the left travel control valve 154L can be shifted by the control lever 108a as described above. On the other hand, when the drive signal St is turned off, the travel lock solenoid control valve 158 is returned to a cutoff position 158B on the left side in FIG. 28 by the restoring force of a spring 158b, whereupon the introducing line 160a is cut off from the introducing line 160b and the introducing line 160b is communicated with a reservoir line 162a led to a reservoir 162. As a result, a pressure in the introducing line 160b is reduced to the reservoir pressure, thereby disabling the operation of the left travel control valve 154L by the control lever 108a.

Returning to FIG. 27, the first crusher control valve 153 is operated by a pilot pressure that is generated from the pilot pump 146 and reduced to a predetermined pressure through the crusher forward-rotation solenoid control valve 159F and the crusher backward-rotation solenoid control valve 159R both incorporated in the operating valve device 157.

More specifically, the crusher forward-rotation solenoid control valve 159F and the crusher backward-rotation solenoid control valve 159R, shown in FIG. 28, include solenoids 159Fa, 159Ra driven respectively by drive signals Scr1, Scr2 from the controller 161. The first crusher control valve 153 is shifted upon inputting of the drive signals Scr1, Scr2.

When the drive signal Scr1 is turned on and the drive signal Scr2 is turned off, the crusher forward-rotation solenoid control valve 159F is shifted to a communicating position 159FA on the right side in FIG. 28, and the crusher backward-rotation solenoid control valve 159R is returned to a cutoff position 159RB on the left side in FIG. 28 by the restoring force of a spring 159Rb. Therefore, the pilot pressure from the pilot pump 146 is introduced to a driving sector 153a of the first crusher control valve 153 via introducing lines 163a, 163b, and an introducing line 164b is communicated with the reservoir line 162a for reduction to the reservoir pressure, whereby the first crusher control valve 153 is shifted to a shift position 153A on the upper side in FIG. 27. As a result, the hydraulic fluid from the first hydraulic pump 145A is supplied to the crusher hydraulic motor 24 through the delivery line 149A, the center bypass line 155A, and the shift position 153A of the first crusher control valve 153, thereby driving the crusher hydraulic motor 24 to rotate in the forward direction.

Likewise, when the drive signal Scr1 is turned off and the drive signal Scr2 is turned on, the crusher forward-rotation solenoid control valve 159F is returned to a cutoff position 159FB on the left side in FIG. 28 by the restoring force of a spring 159Fb, and the crusher backward-rotation solenoid control valve 159R is shifted to a communicating position 159RA on the right side in FIG. 28. Therefore, the pilot pressure is introduced to a driving sector 153b of the first crusher control valve via introducing lines 164a, 164b, and the introducing line 163b is communicated with the reservoir pressure, whereby the first crusher control valve 153 is shifted to a shift position 153B on the lower side in FIG. 27. As a result, the hydraulic fluid from the first hydraulic pump 145A is supplied to the crusher hydraulic motor 24 through the shift position 153B of the first crusher control valve 153, thereby driving the crusher hydraulic motor 24 to rotate in the backward direction.

When the drive signals Scr1, Scr2 are both turned off, the crusher forward-rotation solenoid control valve 159F and the crusher backward-rotation solenoid control valve 159R are both returned to cutoff positions 159FB, 159RB on the left side in FIG. 28 by the restoring forces of the springs 159Fb, 159Rb. Therefore, the first crusher control valve 153 is returned to a neutral position 153C, shown in FIG. 27, under balance between the urging forces of springs 153c, 153d, whereby the hydraulic fluid from the first hydraulic pump 145A is cut off and the crusher hydraulic motor 24 is stopped.

(c) Second Control Valve Device

FIG. 29 is a hydraulic circuit diagram showing a detailed construction of the second control valve device 147B. Referring to FIG. 29, the second control valve device 147B has substantially same structure as the first control valve device 147A. Numeral 165 denotes a second crusher control valve and 154R denotes a right travel control valve, which serve to supply the hydraulic fluid delivered from the second hydraulic pump 145B to the right travel hydraulic motor 14R and the crusher hydraulic motor 24, respectively. Those control valves 154R, 165 are arranged on a center bypass line 155B, which is connected to the delivery line 149B of the second hydraulic pump 145B, in the order of the right travel control valve 154R and the second crusher control valve 165 from the upstream side.

The right travel control valve 154R is operated by a pilot pressure generated from the control lever device 109 as with the left travel control valve 154L. When the control lever 109a is operated in the direction of arrow (g) in FIG. 29 (or in the opposite direction, the correspondent relation is equally applied to the following description), the pilot pressure is introduced to a driving sector 154Ra (or 154Rb) of the right travel control valve 154R through a pilot line 166a (or 166b), whereupon the right travel control valve 154R is shifted to an upper shift position 154RA (or a lower shift position 154RB) in FIG. 29. Then, the hydraulic fluid from the second hydraulic pump 145B is supplied to the right travel hydraulic motor 14R through the shift position 154RA (or the lower shift position 154RB) of the right travel control valve 154R, thereby driving the right travel hydraulic motor 14R to rotate in the forward direction (or in the backward direction). When the control lever 109a is operated to a neutral position shown in FIG. 29, the right travel control valve 154R is returned to a neutral position, shown in FIG. 29, under balance between the urging forces of springs 154Rc, 154Rd, whereby the right travel hydraulic motor 14R is stopped.

As with the control lever device 108, the pilot pressure to the control lever device 109 is supplied from the pilot pump 146 through the travel lock solenoid control valve 158. Accordingly, as with the control lever device 108, when the drive signal St inputted to the solenoid 158a of the travel lock solenoid control valve 158 is turned on, the above-described operation of the right travel control valve 154R with the control lever 109a is enabled, and when the drive signal St is turned off, the above-described operation of the right travel control valve 154R with the control lever 109a is disabled.

As with the first crusher control valve 153, the second crusher control valve 165 is operated by a pilot pressure that is generated from the pilot pump 146 and reduced to a predetermined pressure through the crusher forward-rotation solenoid control valve 159F and the crusher backward-rotation solenoid control valve 159R both incorporated in the operating valve device 157.

More specifically, when the drive signal Scr1 from the controller 161 is turned on and the drive signal Scr2 is turned off, the pilot pressure from the pilot pump 146 is introduced to a driving sector 165a of the second crusher control valve 165 via the introducing lines 163a, 163b, and the introducing line 164b is communicated with the reservoir line 162a for reduction to the reservoir pressure, whereby the second crusher control valve 165 is shifted to a shift position 165A on the upper side in FIG. 29. As a result, the hydraulic fluid from the second hydraulic pump 145B is supplied to the crusher hydraulic motor 24 through the shift position 165A of the second crusher control valve 165, thereby driving the crusher hydraulic motor 24 to rotate in the forward direction.

Likewise, when the drive signal Scr1 is turned off and the drive signal Scr2 is turned on, the pilot pressure is introduced to a driving sector 165b of the second crusher control valve via the introducing lines 164a, 164b, and the introducing line 163b is communicated with the reservoir pressure, whereby the second crusher control valve 165 is shifted to a shift position 165B on the lower side in FIG. 29. As a result, the hydraulic fluid from the second hydraulic pump 145B is supplied to the crusher hydraulic motor 24 through the shift position 165B of the second crusher control valve 165, thereby driving the crusher hydraulic motor 24 to rotate in the backward direction.

When the drive signals Scr1, Scr2 are both turned off, the second crusher control valve 165 is returned to a neutral position 165C, shown in FIG. 29, under balance between the urging forces of springs 165c, 165d, whereby the crusher hydraulic motor 24 is stopped.

As seen from the above description, the first crusher control valve 153 and the second crusher control valve 165 operate in the same manner in response to the drive signals Scr1, Scr2 applied to the solenoid control valves 159F, 159R, thereby causing the hydraulic fluids from the first hydraulic pump 145A and the second hydraulic pump 145B to be supplied to the respective crusher hydraulic motors 24, 24 while partly joining with each other.

(d) Third Control Valve Device

Though neither shown nor explained in detail, the third control valve device 147C includes, for example, the carrier conveyor control valve connected to the carrier conveyor hydraulic motor 39, the pressing conveyor control valve connected to the pressing conveyor hydraulic motor 49, the carrying-out conveyor control valve connected to the carrying-out conveyor hydraulic motor 68, the magnetic separator control valve connected to the magnetic separator hydraulic motor 75, and the pressing conveyor elevating control valve connected to the hydraulic cylinders 57, 57 for up and down moving the pressing conveyor. Those control valves are each a solenoid selector valve or a solenoid proportional valve that is provided with solenoid driving sectors and is shifted upon inputting of a drive signal from the controller 161, thereby supplying the hydraulic fluid from the third hydraulic pump 145C to the corresponding hydraulic actuator for driving it.

(e) Control Panel and Basic Functions of Controller

The control panel 148 has, though not shown, various buttons, switches, dials, etc., including, e.g., a forward rotation button, a stop button and a backward rotation button to start up the forward rotation of the crushing rotor 20, to stop it, and to start up the backward rotation thereof, respectively, as well as an operation mode selecting switch for selecting one of a travel mode for causing the machine to travel and a crushing mode for performing crushing work.

When the operator operates any of those various buttons, switches, and dials, a corresponding operation signal is inputted to the controller 161. In accordance with the operation signal from the control panel 148, the controller 161 produces the drive signals St, Scr1 and Scr2 supplied to the solenoids 158a, 159Fa and 159Ra of the travel lock solenoid control valve 158, the crusher forward-rotation solenoid control valve 159F, and the crusher backward-rotation solenoid control valve 159R, and then outputs the produced drive signals to the corresponding solenoids.

For example, when “travel mode” is selected by the mode selecting switch on the control panel 148, the drive signal St supplied to the travel lock solenoid control valve 158 is turned on so that the travel lock solenoid control valve 158 is shifted to the communicating position 158A on the right side in FIG. 28, thereby enabling the left and right travel control valves 154L, 154R to be operated by the control levers 108a, 109a. When “crushing mode” is selected by the mode selecting switch on the control panel 148, the drive signal St supplied to the travel lock solenoid control valve 158 is turned off so that the travel lock solenoid control valve 158 is returned to the cutoff position 158B on the left side in FIG. 28, thereby disabling the operation of the left and right travel control valves 154L, 154R by the control levers 108a, 109a.

Also, when the crushing rotor forward-rotation (or backward-rotation) button on the control panel 148 is depressed, the drive signal Scr1 (or the drive signal Scr2) supplied to the solenoid 159Fa of the crusher forward-rotation solenoid control valve 159F (or the solenoid 159Ra of the crusher backward-rotation solenoid control valve 159R) is turn on and the drive signal Scr2 (or the drive signal Scr1) supplied to the solenoid 159Ra of the crusher backward-rotation solenoid control valve 159R (or the solenoid 159Fa of the crusher forward-rotation solenoid control valve 159F) is turned off so that the first and second crusher control valves 153, 165 are shifted to the shift positions 153A, 165A on the upper side in FIGS. 27 and 29 (or the shift positions 153B, 165B on the lower side). Thereby, the hydraulic fluids from the first and second hydraulic pumps 145A, 145B are joined and supplied to drive the crusher hydraulic motors 24 for starting the crusher 16 to rotate forward (or backward).

Then, when the crushing rotor stop button is depressed, the drive signals Scr1, Scr2 are both turned off, causing the first and second crusher control valves 153, 165 to be returned to the neural positions 153C, 165C shown in FIGS. 27 and 29. As s result, the crusher hydraulic motors 24 are stopped to cease the operation of the crusher 16.

(f) Crusher Stopping Function of Controller

In the hydraulic drive system of the self-propelling wood crushing machine of this embodiment, which has the basic construction described in above (a) to (e), when the limit switch 124 detects the rotation of the rotatable portion 89′B of the fixed blade support, the crusher 16 is stopped.

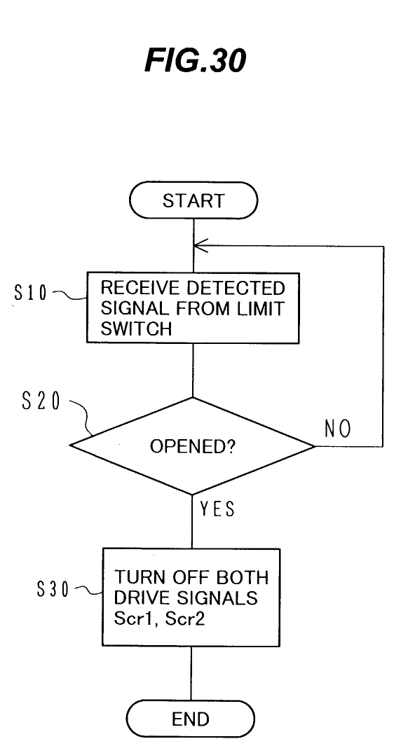

FIG. 30 is a flowchart representing control details concerned with crusher stop control in the control functions executed by the controller 161. Referring to FIG. 30, in step 10, the controller first receives a detected signal from the limit switch 124. Then, in step 20, it is determined in accordance with the detected signal received in step 10 whether the rotatable portion 89′B of the fixed blade support 89′ has rotated. If the determination result is “NO”, the controller returns to step 10 for repeating the same procedure as described above.

If the determination result in step 20 is “YES”, the controller proceeds to step 30 where the drive signal Scr1 supplied to the solenoid 159Fa of the crusher forward-rotation solenoid control valve 159F and the drive signal Scr2 supplied to the solenoid 159Ra of the crusher backward-rotation solenoid control valve 159R are both turned off. The first and second crusher control valves 153, 165 are thereby returned to the neutral positions 153C, 165C shown in FIGS. 27 and 29. As a result, the crusher hydraulic motors 24 are stopped and the crusher 16 is also stopped.

Note that, in the self-propelling wood crushing machine of this embodiment, the construction other than described above is the same as that of the one embodiment of the self-propelling wood crushing machine described above.

In the above construction, comparing with terms used in claims, the pressing conveyor support mechanism 55′ constitutes a mechanism for up and down movably supporting the pressing conveyor, and the pressing conveyor hydraulic motors 49′ constitute driving means for rotationally driving the pressing conveyor. The spacer member 128 constitutes a spacer capable of changing the gap between the second fixed blade and the crushing rotor.

Also, the limit switch 124 constitutes detecting means for detecting the rotation of the rotatable portion, and the controller 161 (particularly, step 30 in the flowchart of FIG. 30 executed by the controller 161) constituted strop control means for controlling the rotation of the crushing rotor to be stopped.

The operation of the other embodiment of the self-propelling wood crushing machine of the present invention, having the above-described construction, will be described below.

2-(I) Traveling

When the operator selects the “travel mode” with the mode selection switch on the control panel 148 and then operates the left and right control levers 108a, 109a in the cab 77, the left and right travel control valves 154L, 154R are shifted depending on the lever operation, whereupon the hydraulic fluids from the first and second hydraulic pumps 145A, 145B are supplied to the left and right travel hydraulic motors 14L, 14R through the left and right travel control valves 154L, 154R. The endless tracks 13 are thereby driven to move the travel devices 11 forward or backward.

2-(II) Crushing Work

When the operator selects the “crushing mode” with the mode selection switch on the control panel 148 and then depresses the crushing rotor forward-rotation button, the controller 161 turns on the drive signal Scr1 supplied to the solenoid driving sectors 153a, 165a of the first and second crusher control valves 153, 165, and turns off the drive signal Scr2 supplied to the solenoid driving sectors 153b, 165b thereof, whereupon the first and second crusher control valves 153, 165 are shifted to the shift positions 153A, 165A.

Likewise, when the operator operates the various buttons and switches, the carrier conveyor control valve, the pressing conveyor control valve, the carrying-out conveyor control valve, and the magnetic separator control valve are shifted correspondingly.

As a result, the hydraulic fluid from the third hydraulic pump 145C is supplied to the magnetic separator hydraulic motor 75, the carrying-out conveyor hydraulic motor 68, the pressing conveyor hydraulic motors 49, and the carrier conveyor hydraulic motor 39, whereby the magnetic separator 8, the carrying-out conveyor 7, the pressing conveyor 5′, and the carrier conveyor 3 are started up. On the other hand, the hydraulic fluids from the first and second hydraulic pumps 145A, 145B are supplied to the crusher hydraulic motors 24 while partly joining with each other, causing the crusher 16 to start the forward rotation. Though not shown, when the control valve for up and down moving the pressing conveyor is in its neutral position, bottom-side lines and rod-side lines of the hydraulic cylinders 57, 57 for up and down moving the pressing conveyor are communicated with each other. In the normal state, therefore, the pressing conveyor 5′ is held by the pressing conveyor support mechanism 55′ to be freely slidable in the vertical direction.

As with the one embodiment described above, when wood to be crushed is loaded into the hopper 2 in the above condition, the wood to be crushed is fed toward the crusher 16 by the carrier conveyor 3 and then introduced to the crusher 16 under cooperation of the carrier conveyor 3 and the pressing conveyor 5′ with the rotation of the feeding belt 133 while being pressed and gripped by the pressing conveyor 5′ under the action of its dead load. The introduced wood to be crushed is relatively roughly crushed by the crushing bits 18, and then successively hits against the anvils 27a, 27b and 27c for further crushing into smaller pieces. When the sizes of the wood pieces crushed in that way are reduced to such an extent as enough to pass through the openings of the sieving member 26. The crushed wood pieces having sizes reduced to such an extent as enough to pass through meshes of the grate 26, the crushed wood pieces pass through the meshes and are dropped on the conveyor belt 69 of the carrying-out conveyor 7 through the chute 83. The crushed wood pieces thus dropped are transported toward the rear side by the carrying-out conveyor 7 which magnetic materials mixed in the crushed wood pieces are attracted by the magnetic separator 8. Finally, the crushed wood pieces are delivered as recycled materials to the side on the back of the self-propelling wood crushing machine.

2-(III) Operation of Moving Variable Anvil Back-and-Forth

In this embodiment, by fastening the bolts 127 for moving the variable anvil back and forth in a state where the inserted portion 128a of the spacer member 128 is inserted between the variable anvil 27b or 27c and the closure plate 89′e1, the variable anvil 27b or 27c is fixed to the fixed portion 89′A of the fixed blade support while the distance between the variable anvil 27b or 27c and the closure plate 89′e1 is held at the longer size L3 (or the shorter size L4) of the rectangular section of the spacer inserted portion 128a.

A description is now made of, e.g., the procedures for changing the distance between the variable anvil 27b and the closure plate 89′e1 to be given by the shorter size L4 of the rectangular section of the spacer inserted portion 128a from the state where the variable anvils 27b, 27c are both fixed such that the distance between each of the variable anvils 27b, 27c and the closure plate 89′e1 is fixed to be given by the longer size L3 of the rectangular section of the spacer inserted portion 128a as shown in FIG. 15.

First, the back-and-forth moving bolts 127 fixing the variable anvil 27b are loosened to such an extent as allowing the inserted portion 128a of the spacer member 128 to be withdrawn. Then, the two set bolts 130 fixing the connecting portion 128c to the spacer fixing plate 129 are loosened, and the spacer member 128 is withdrawn out of the fixed portion 89′A of the fixed blade support by grasping the grip portion 128b. After rotating the spacer member 128 by 90 degrees clockwise (or counterclockwise), the inserted portion 128a is inserted again between the variable anvil 27b and the closure plate 89′e1. Thereafter, by fastening the two set bolts 130 and further fastening the back-and-forth moving bolts 127, the variable anvil 27b is secured to the fixed portion 89′A of the fixed blade support while the distance between the variable anvil 27b and the closure plate 89′e1 is held at the shorter size L4 of the rectangular section of the spacer inserted portion 128a.

Thus, with this embodiment, the variable anvils 27b, 27c can be each adjusted in two steps in the back-and-forth direction relative to the crushing rotor 20 by a simple method of just rotating the spacer member 128, which has been withdrawn out of between the variable anvil 27b or 27c and the fixed portion 89′A of the fixed blade support, by 90 degrees clockwise (or counterclockwise), and then inserting the spacer member again.

The self-propelling wood crushing machine of this embodiment having the above-described construction can provide advantages given below.

2-(1) Advantages Due to Equipment Layout Positions

In the self-propelling wood crushing machine of this embodiment, the various units of equipments are disposed substantially in the same way as those in the above-described one embodiment. Therefore, this embodiment can also reduce the overall size of the self-propelling wood crushing machine.

2-(2) Advantages Due to Back-and-Forth Movement of Variable Anvil

With this embodiment, as described above, the variable anvils 27b, 27c can be each easily adjusted in two steps in the back-and-forth direction relative to the crushing rotor 20 by utilizing the spacer member 128. As with the above-described one embodiment, therefore, the crushed pieces falling within the desired piece size range can be obtained while maintaining good crushing efficiency.

2-(3) Advantages Due to Crusher Stop Control

In this embodiment, as described above, when the rotatable portion 89′B of the fixed blade support rotates, the limit switch 124 outputs the detected signal to the controller 161, whereupon the controller 161 stops the crusher hydraulic motors 24.

With that feature, when wood to be crushed, foreign matters, etc., which have such a high hardness as raising a difficulty in crushing from the standpoint of the machine performance, are introduced to the crusher 16, the rotatable portion 89′B of the fixed blade support 89′ is rotated, allowing those materials to be ejected to the outside of the crusher 16. Responsively, the controller 161 stops the rotation of the crushing rotor 20. As a result, the crushing rotor 20, the crushing bits 18, or the surrounding structures can be prevented from being damaged by hard wood to be crushed, hard foreign matters, etc.

In this connection, if the fixed blade support 89′ is entirely rotate, this would be not preferable from the viewpoint of safety because a large opening is created around the crushing rotor 20 and a large amount of crushed wood is ejected. On the other hand, with this embodiment, since only the rotatable portion 89′B of the fixed blade support 89′ is rotated, the smallest necessary opening is created and therefore damage of the various components can be prevented while avoiding the crushed wood from being ejected in large amount.

2-(4) Others

2-\mathring{1} Advantages Due to Entanglement Preventing Wall

In the self-propelling wood crushing machine of this embodiment, the outer peripheral side of the crushing rotor 20 is covered over an area greater than a half thereof with path defining means comprising the grate 26, the fixed blade support 89′, and the grate support structure 131, so that a crushed wood flow passage P (see FIG. 16) is formed by the crushing rotor 20 and path defining means. Also, an opening (open space Q, see FIG. 16) for taking in the wood to be crushed is formed on the side closer to the pressing roller 42′ and the feed roller 29, i.e., on the side where the wood to be crushed is introduced. If the open space Q is left as it is, there is a possibility that the crushed wood having flown through the crushed wood flow passage P with the rotation of the crushing rotor 20 may flow in a reversed direction from the open space Q due to centrifugal forces caused upon the rotation of the crushing rotor 20 and may fly out toward the pressing roller 42′ and the feed roller 29.

In this embodiment, the outer periphery of the open space Q is closed at its lower side by the wood to be crushed, which is subsequently introduced, and the pressing conveyor 5′, and closed at its upper side, as described above, by the pressing conveyor 5′ and the crushed-wood entanglement preventing wall 143 disposed in a up and down movable manner. In particular, the entanglement preventing wall 143 is disposed such that its lower end is positioned at a level substantially the same as or lower than at least the axis position X of the pressing roller 42′. With such an arrangement, even when the crushed wood flies from the crushed wood flow passage P toward the pressing conveyor 5′ that is rotated upward looking from the crushing rotor 20 side, the crushed wood flying at a level higher than the axis position X of the pressing roller 42′ is always blocked by the entanglement preventing wall 143 and dropped downward. Also, even when the crushed wood flies at a level lower than the entanglement preventing wall 143 and attached to the rugged surface of the feeding belt 133 of the pressing conveyor 5′, that crushed wood is dropped downward under the action of gravity, vibration, etc. because the rugged surface of the feeding belt 133 is in a state inclined downward relative to the horizontal direction at such a level.

Accordingly, a part of the crushed wood flying from the crushing rotor 20 side can be suppressed from riding over the pressing roller 42′ with the rotation of the pressing roller 42′ and from reversely flowing out to the side where the wood to be crushed is introduced. As a result, the productivity can be improved.

2-\mathring{2} Advantages Due to Resilient Support Structure of Pressing Roller

In this embodiment, the pressing roller 42′ of the pressing conveyor 5′ is resiliently supported at its rotary shaft by the movable bearings 141b such that the pressing roller 42′ is displaceable toward the side opposite to the crushing rotor 20. With that feature, even when the crushed wood is caught and entangled between the pressing roller 42′ and the entanglement preventing wall 143 for some reason in spite of the entanglement preventing wall 143 being disposed as described above in 2-\mathring{1}, the pressing roller 42′ is retracted toward the drive roller 43′ side (i.e., the side opposite to the crushing rotor 20) and hence the drive roller 43′ of the pressing conveyor 5′ can be prevented from being subjected to an excessive driving load.

2-\mathring{3} Advantages Due to Openings of Pressing Plate

In this embodiment, the openings 138 for preventing clogging of wood are formed in the pressing plate 137 at positions corresponding to the mount portions to the link member 136. With that feature, even if the crushed wood is entangled as described above in 2-\mathring{2} and then enters and resides inside the circulating feeding belt 133, the crushed wood can be ejected to the outside of the feeding belt 133 through the openings 138.

2-\mathring{4} Advantages Due to Crushed Wood Fly-out Preventing Portion of Guide Plate

As described above in 2-\mathring{1}, the open space Q is formed along the outer periphery of the crushed wood flow passage P on the side where the wood to be crushed is introduced. If the open space Q is left as it is, there is a possibility that the crushed wood having flown through the crushed wood flow passage P with the rotation of the crushing rotor 20 may fly out toward the pressing roller 42′ and the feed roller 29.

In this embodiment, the guide plate member 132 is disposed around the crushing outer diameter R in a wood loading area. Then, the crushed wood fly-out preventing portion 132a of the guide plate member 132 is disposed such that the distance to the crushing outer diameter R is gradually reduced in the rotating direction of the crushing rotor 20, i.e., that it forms the predetermined angle θ with respect to the direction tangential to the crushing outer diameter R. With such an arrangement, the crushed wood having flown with the rotation through the crushed wood flow passage P strikes against the wood fly-out preventing portion 132a of the guide plate member, whereby the flying-out crushed wood tends to undergo forces acting in such an oblique direction as urging the crushed wood to approach the crushing outer diameter R (i.e., as preventing the crushed wood from flying out) and the crushed wood is suppressed from flying out toward the pressing conveyor 5′ side, i.e., the side where the wood to be crushed is introduced to the crushing rotor 20. Consequently, as with above 2-\mathring{1}, a part of the crushed wood flying from the crushing rotor 20 side can be suppressed from reversely flowing out to the side where the wood to be crushed is introduced. This can also contribute to improving the productivity.

2-\mathring{5} Advantages Due to Wood Material Introducing Portion of Guide Plate Member

In this embodiment, as described above, the wood material introducing portion 132b of the guide plate member is arranged such that its end 132ba on the side closer to the feed roller 29 is positioned near the locus S of rotation of the feed roller 29. With such an arrangement, even when a part of the wood to be crushed, which has been fed by the carrier conveyor 3, is not introduced to the crushing rotor 20 side and tends to slip into the side under the feed roller 29 while being caught with the feed roller 29, the wood to be crushed can be prevented from slipping into the side under the feed roller 29 by the end of the wood material introducing portion, and hence can be surely introduced to the crushing rotor 20 side.

Furthermore, in this embodiment, the wood material introducing portion 132b of the guide plate member is disposed such that its level in the height direction is lower than the uppermost position of the locus S of rotation of the feed roller. This arrangement provides the advantage as follows. When positioning the end of the wood material introducing portion 132b in a substantially horizontal state as close as possible to the feed roller 29 having a substantially circular shape, the gap between the plate end and the feed roller can be minimized by positioning the plate end close to not a top portion of the circular feed roller, but a portion lower than the top portion, because the guide plate member 132 is a plate having a predetermined thickness and has a difficulty (or a limit) in machining the plate end into a concave shape (so-called raked portion) having a curvature. Accordingly, in this embodiment, by setting the level of the wood material introducing portion 132a in the height direction to be lower than the uppermost position of the locus S of rotation of the feed roller, the end of the wood material introducing portion 132a can be positioned satisfactorily close to the locus S of rotation of the feed roller, and the wood to be crushed can be more surely prevented from slipping into the side under the feed roller.

While the one embodiment and the other embodiment of the present invention have been described above, by way of example, in connection with a wood crushing machine including, as a crusher, the so-called impact crusher in which blades (crushing bits 18) are mounted to the outer periphery of the crushing rotor 20, the present invention is not limited to those embodiments. The present invention is also applicable to other types of crushers, such as a crusher having cutters mounted on parallel shafts and rotated in opposite directions to shear materials to be crushed (e.g., 2-axis shearing machine including the so-called shredder), a rotary crusher in which a pair of assemblies comprising a roll-shaped rotating body (rotor) and crushing blades mounted to the rotating body are rotated in opposite directions and materials to be crushed are crushed while being sandwiched between the rotating bodies (e.g., 6-axis crusher including the so-called roll crusher), and a wood crushing machine including the so-called wood chipper for crushing wood materials into chips. Any of those cases can also provide similar advantages to those described above.

### INDUSTRIAL APPLICABILITY

According to the invention of claim 1, traveling means, a crusher, feeding means, a pressing conveyor, a carrying-out conveyor, and a plurality of hydraulic actuators for driving the traveling means, the crusher, the feeding means, the pressing conveyor and the carrying-out conveyor, respectively, are arranged on a body frame in concentrated layout. Therefore, those components can be efficiently mounted without wasteful use of spaces, and the overall size of an self-propelling wood crushing machine can be reduced.

According to the invention of claim 5, a fixed blade is disposed on a fixed blade support, which is provided around a crushing rotor, in a back-and-forth movable manner such that a gap between the fixed blade and the crushing rotor can be changed. Therefore, the size of crushed material pieces can be adjusted to fall within a desired range while maintaining good crushing efficiency.

1. An self-propelling wood crushing machine comprising:
a body frame (10);
traveling means (11) provided at both ends of said body frame (10) in the widthwise direction;
a rotary crusher (16) provided substantially at the center of said body frame (10) in the longitudinal direction and including a crushing rotor (20) having a crushing bit (18) disposed on an outer periphery thereof;
feeding means (3) provided on one side of said body frame (10) in the longitudinal direction to extend in the longitudinal direction of said body frame (10) and feeding wood to be crushed to said crusher (16);
a pressing conveyor (5; 5′) comprising a pressing roller (42; 42′) provided above said feeding means (3) in the vicinity of said crusher (16), a drive roller (43, 43′) provided on the side opposite to said pressing roller (42; 42′) away from said crusher (16), and a feeding belt (31; 133) stretched between and wound around said pressing roller (42; 42′) and said drive roller (43, 43′), said pressing conveyor (5; 5′) pressing the wood to be crushed while moving up and down, thereby introducing the wood to said crusher (16) under cooperation with said feeding means (3); and
a power unit (9) provided on the other side of said body frame (10) in the longitudinal direction.

2. An self-propelling wood crushing machine according to claim 1, further comprising a mechanism (55; 55′) for up and down movably supporting said pressing conveyor (5; 5′), wherein said mechanism (55; 55′) for up and down movably supporting said pressing conveyor (5; 5′) comprises a slider (58; 58′) for holding said pressing conveyor (5; 5′), and hydraulic cylinders (57) provided at both ends of said slider (58; 58′).

3. An self-propelling wood crushing machine according to claim 2, wherein said mechanism (55; 55′) for up and down movably supporting said pressing conveyor (5; 5′) further comprises a link-type guide member (142) for coupling said slider (58; 58′) and a frame (92) of said crusher (16).

4. An self-propelling wood crushing machine according to any one of claims 1 to 3, further comprising driving means (49; 49′) for rotationally driving said pressing conveyor (5; 5′) contained inside said driver roll (43, 43′).

5. An self-propelling wood crushing machine according to any one of claims 1 to 4, wherein said feeding belt (133) comprises an endless link (136) stretched between and wound around said pressing roller (42′) and said drive roller (43′), and a plurality of pressing plates (137) having a substantially triangular cross-section and disposed side by side along an outer periphery of said link (136) in the feeding direction of the wood to be crushed.

6. An self-propelling wood crushing machine according to any one of claims 1 to 5, wherein said pressing conveyor (5′) comprises a plurality of pressing rollers (42′) arranged side by side in the widthwise direction of said body frame (10), a plurality of drive rollers (43′) arranged side by side in the widthwise direction of said body frame (10) in an opposed relation to said plurality of pressing rollers (42′), and a plurality of feeding belts (133) stretched between and wound around said plurality of pressing roller (42′) and said plurality of drive roller (43′).

7. An self-propelling wood crushing machine according to any one of claims 1 to 6, further comprising a fixed blade support (89′) supporting at least one fixed blade (27a) positioned around a locus (R) of rotation of said crushing bit (18) and having a rotatable portion (89′B) rotatable in a direction in which said fixed blade (27a) is released from an excessive load, when the excessive load is imposed on said fixed blade (27a), detecting means (124) for detecting rotation of said rotatable portion (89′B), and stop control means (161) for controlling rotation of said crushing rotor (20) to be stopped when the rotation of said rotatable portion (89′B) is detected by said detecting means (124).

8. A wood crushing machine comprising:
a crushing rotor (20) having a crushing bit (18) disposed on an outer periphery thereof;
fixed blades (27a, 27b, 27c) disposed in a back-and-forth adjustable or replaceable manner on a fixed blade support (89; 89′) provided around said crushing rotor (20) such that a gap between said fixed blades and said crushing rotor (20) is changeable; and
a sieving member (26) disposed with a gap left relative to said crushing rotor (20).

9. A wood crushing machine comprising:
a crushing rotor (20) having a crushing bit (18) disposed on an outer periphery thereof;
a first fixed blade (27a) disposed on a fixed blade support (89; 89′) provided around said crushing rotor (20);
second fixed blades (27b, 27c) disposed in a back-and-forth adjustable or replaceable manner on a fixed blade support (89; 89′) provided around said crushing rotor (20) such that a gap between said second fixed blades and said crushing rotor (20) is changeable; and
a sieving member (26) disposed with a gap left relative to said crushing rotor (20).

10. A wood crushing machine according to claim 9, wherein said second fixed blades (27b, 27c) comprises a plurality of fixed blades disposed such that gaps between the fixed blades and said crushing rotor (20) are gradually decreased in the rotating direction of said crushing rotor (20).

11. A wood crushing machine according to claim 9 or 10, further comprising a spacer (128) capable of changing the gap between said second fixed blades (27b, 27c) and said crushing rotor (20) is extractably inserted between said second fixed blades (27b, 27c) and said fixed blade support (89′).

12. A wood crushing machine according to claim 11, wherein said spacer has a rectangular cross-sectional shape.
